(19) United States
(12) Patent Application Publication
(10) Pub. No.: US 2022/0056756 A1
(43) Pub. Date: Feb. 24, 2022

(54) Systems, Devices, and Methods for Variable Visibility Barriers

(71) Applicants: Jonathan Lamon Stewart, Heber City, UT (US); Elaine Aloma Stewart, Heber City, UT (US)

(72) Inventors: Jonathan Lamon Stewart, Heber City, UT (US); Elaine Aloma Stewart, Heber City, UT (US)

(21) Appl. No.: 17/001,365

(22) Filed: Aug. 24, 2020

(51) Int. Cl. E06B 7/096; E04H 17/14

(52) U.S. Cl. CPC E06B 7/096; E04H 2017/1452; E04H 17/1417

(57) ABSTRACT

A barrier includes a post, a support beam coupled to the post, and multiple slats coupled to the support beam. The multiple slats are also coupled to a flexible elongate member. The flexible elongate member is also coupled to a driving mechanism. As the driving mechanism moves the flexible elongate member, the flexible elongate member causes the multiple slats to rotate between a closed position and various open positions.

### TECHNICAL FIELD

The present disclosure relates generally to barriers for modifying visibility. In particular, a driving mechanism mechanically coupled to the slats of a barrier may rotate the slats to an open position allowing visibility through the barrier or rotate the slats to a closed position preventing visibility through the barrier.

### BACKGROUND

Barriers are generally used for delineating boundary lines between property or more generally for partitioning sections of various spaces. Typically, barriers such as fences, walls, or dividers have static characteristics. In particular, most residential fences are either privacy fences, which do not allow visibility through the fence, or non-privacy fences which allow near total visibility through the fence. Particularly in high-density locations, in which property lots are small and close together, at a time when a large number of people including neighbors are outside of their dwellings, a privacy fence is advantageous in allowing a property owner to maintain privacy. However, at times when few or no people are outside their dwellings, the increased privacy a privacy fence provides is not necessary and may decrease a property owner's view or general feeling of openness. There is a need and demand for a barrier, such as a fence, wall, or divider, which may variably adjust visibility such that it may provide the needed privacy of a privacy fence when appropriate but allow visibility similar to that of a non-privacy fence when desired.

### SUMMARY

Embodiments of the present disclosure are systems, devices, and methods for a variable visibility barrier using rotating slats. A barrier may include a structure designed to support multiple slats parallel and adjacent to one another. The barrier may include an electric motor which may be powered by traditional residential or commercial power sources or by renewable sources, such as solar, wind, or hydroelectric power sources. The electric motor may be connected to a battery. The electric motor may turn flexible elongate member extending along the barrier. As the flexible elongate member turns, the slats of the barrier may be rotated between a closed position preventing visibility and an open position allowing visibility through the barrier, or vice versa. The electric motor may be engaged when an input from a user is received through a user interface. The user interface may be positioned on the barrier itself. The user input may be received through wired or wireless means of communication.

Some embodiments of the present disclosure allow a user to move the slats of the barrier between a closed and open position and vice versa by grasping and moving or rotating a handle connected to the barrier. Different embodiments of the present disclosure provide for varying levels of automation, expense, and reliability, among other general characteristics.

In an exemplary aspect, a barrier is provided. The barrier comprises a post; a support beam coupled to the post; one or more slats coupled to the support beam wherein the one or more slats are additionally coupled to a flexible elongate member; and a driving mechanism coupled to the flexible elongate member, wherein the driving mechanism is configured to move the flexible elongate member, and wherein the flexible elongate member causes the one or more slats to rotate as it is moved.

In some aspects, the barrier comprises a second flexible elongate member wherein the driving mechanism and the slats are coupled to the second flexible elongate member. In some aspects, the slats are positioned directly adjacent to one another such that, at a first closed position, the slats prevent visibility through the fence and, at a second open position, the slats allow visibility through the fence. In some aspects, the slats comprise interlocking geometries. In some aspects, the flexible elongate member is a chain. In some aspects, the driving mechanism is coupled to a first sprocket configured to receive the chain and wherein the slats are coupled to additional gears configured to receive the chain. In some aspects, the driving mechanism is configured to turn the first gear causing the slats to rotate between one or more open positions and a closed position. In some aspects, the flexible elongate member is a belt and wherein the driving mechanism further comprises a first pulley configured to receive the belt and wherein the slats are each additionally coupled to an additional pulley configured to receive the belt such that when the driving mechanism turns the first pulley, the slats rotate between one or more open positions and a closed position. In some aspects, the driving mechanism is an electric motor configured to move the flexible elongate member upon receiving a user input. In some aspects, the user input is a wireless signal. In some aspects, the electric motor electrically coupled to a battery, and wherein the battery is electrically coupled to and charged by a solar panel. In some aspects, the driving mechanism is configured to be rotated or moved manually by a user.

In an exemplary aspect, a fence is provided. The fence comprises a post; a support beam coupled to the post; and one or more slats coupled to the support beam wherein each slat is additionally coupled to a cross beam configured to be moved laterally by a user.

In some aspects, each slat is coupled to the support beam by a rotating pivot. In some aspects, each slat is configured to rotate between one or more open positions and a closed position when a user moves the cross beam. In some aspects, the slats are positioned directly adjacent to one another such that, at a first closed position, the slats prevent visibility through the fence and, at a second open position, the slats allow visibility through the fence. In some aspects, the slats comprise interlocking geometries. In some aspects, the post is a first post and the one or more support beams each have a first and a second end, the first end being coupled to the first post and the second end being coupled to a second post positioned adjacent to the first post. In some aspects, the one or more slats are positioned parallel to one another.

In an exemplary aspect, a fence is provided. The fence comprises a first post comprising a housing and a driving mechanism positioned within the housing, the driving mechanism being coupled to a flexible elongate member and wherein the driving mechanism is configured to move the flexible elongate member; a second post positioned adjacent to and parallel to the first post; two or more support beams positioned between the first post and second post; and one or more slats comprising a first and a second end, the first end coupled to one of the support beams and the second end coupled to a different support beam, wherein the one or more slats are additionally coupled to the flexible elongate member such that the slats rotate between one or more open positions and a closed position when the driving mechanism moves the flexible elongate member.

Additional aspects, features, and advantages of the present disclosure will become apparent from the following detailed description.

### BRIEF DESCRIPTION OF THE DRAWINGS

Illustrative embodiments of the present disclosure will be described with reference to the accompanying drawings, of which:

FIG. 1 is a schematic diagram of a section of a barrier, according to aspects of the present disclosure.

FIG. 2A is a diagrammatic top view of a slat, according to aspects of the present disclosure.

FIG. 2B is a diagrammatic side view of the slat of FIG. 2A, according to aspects of the present disclosure.

FIG. 3 is a diagrammatic cross-sectional top view of a section of a barrier in a closed position, according to aspects of the present disclosure.

FIG. 4 is a diagrammatic cross-sectional top view of a section of a barrier in an open position, according to aspects of the present disclosure.

FIG. 5 is a diagrammatic side view of a section of a barrier in a closed position, according to aspects of the present disclosure.

FIG. 6 is a diagrammatic side view of a section of a barrier in an open position, according to aspects of the present disclosure.

FIG. 7A is a diagrammatic top view of a slat, according to aspects of the present disclosure.

FIG. 7B is a diagrammatic side view of the slat of FIG. 2A, according to aspects of the present disclosure.

FIG. 8 is a diagrammatic side view of a section of a barrier with an electric motor coupled to two flexible elongate members, according to aspects of the present disclosure.

FIG. 9 is a diagrammatic cross-sectional top view of a section of a barrier, according to aspects of the present disclosure.

FIG. 10 is a diagrammatic side view of a section of a barrier with a manual driving mechanism, according to aspects of the present disclosure.

FIG. 11 is a diagrammatic side view of a section of a barrier with a manual driving mechanism coupled to two flexible elongate members, according to aspects of the present disclosure.

FIG. 12 is a diagrammatic cross-sectional top view of a section of a barrier, according to aspects of the present disclosure.

FIG. 13 is a diagrammatic cross-sectional top view of a section of a barrier, according to aspects of the present disclosure.

FIG. 14 is a diagrammatic side view of a section of a barrier at a post with slats extending from two sides, according to aspects of the present disclosure.

FIG. 15 is a diagrammatic cross-sectional top view of a section of a barrier at a post with slats extending from two sides, according to aspects of the present disclosure.

FIG. 16 is a diagrammatic cross-sectional top view of a section of a barrier at a post with slats extending from two sides, according to aspects of the present disclosure.

FIG. 17A is a diagrammatic top view of a slat, according to aspects of the present disclosure.

FIG. 17B is a diagrammatic side view of the slat of FIG. 17A, according to aspects of the present disclosure.

FIG. 18 is a diagrammatic cross-sectional top view of a section of a barrier in a closed position, according to aspects of the present disclosure.

FIG. 19 is a diagrammatic cross-sectional top view of a section of a barrier in an open position, according to aspects of the present disclosure.

FIG. 20 is a diagrammatic side view of a section of a barrier in a closed position, according to aspects of the present disclosure.

FIG. 21 is a diagrammatic side view of a section of a barrier in an open position, according to aspects of the present disclosure.

FIG. 22 is a diagrammatic side view of a section of a barrier, according to aspects of the present disclosure.

FIG. 23 is a diagrammatic side view of a section of a barrier, according to aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

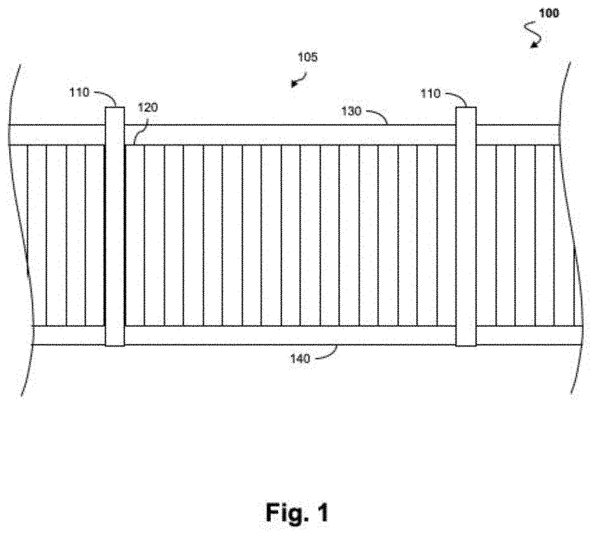

FIG. 1 is a schematic diagram of a section of a barrier 100, according to aspects of the present disclosure. The barrier 100 shown in FIG. 1 may be of any suitable size, shape, type, or may serve any suitable purpose. For example, the barrier 100 may be a fence, wall, a section of a wall, a dividing structure of any type, or any other suitable structure. The barrier 100 may additionally be positioned in any suitable location or orientation relative to its environment and depending on the desired application. For example, the barrier 100 may extend along the border of land or property to delineate property boundaries. In another embodiment, the barrier 100 may positioned horizontally over a structure or may act as the upper surface, ceiling, or roof of a structure. In another embodiment, the barrier 100 may be placed adjacent to windows of a building, either adjacent to an inner or outer surface of a window. In another embodiment, the barrier 100 may be placed within another building or structure or may be positioned outside a building or structure.

The barrier 100 may serve the purpose of allowing a user to modify visibility properties through or across the barrier 100. However, the barrier 100 may serve additional purposes, such as but not limited to, delineating property boundaries, preventing or allowing objects, including inanimate as well as animate objects such as persons, animals, devices, or any other object to pass through the barrier 100, enhancing or restricting air flow or liquid flow through the barrier 100, or may serve any other suitable purpose.

As shown in FIG. 1, the barrier 100 may comprise various components including a plurality of posts 110, a plurality of support members or support beams, including but not limited to upper support beams 130 and lower support beams 140, and a plurality of slats 120. A set of slats 120 positioned between two posts 110 may be referred to as a single panel 105, as shown in FIG. 1.

The posts 110 may be positioned or oriented in any suitable manner. As in the embodiment shown in FIG. 1, the posts 110 may be oriented in a vertical position. In some embodiments, the posts 110 may be mechanically coupled to the ground of the earth, or any other appropriate surface by any suitable means. In some embodiments, the posts 110 may be positioned parallel to one another as shown in FIG. 1 and may be spaced apart from each other by some distance. In other embodiments, the posts 110 need not be positioned or oriented parallel to one another. For example, the posts 110 may be positioned at any angle relative to one another, with slats between the posts oriented and/or sized and shaped accordingly as will be clear to one skilled in the art. The posts 110 may be separated from each other by any suitable distance. For example, the posts may be separated from one another by a distance of 10 cm, 20 cm, 30 cm, 1 m, 2 m, 3 m, 10 m, or more or any suitable distance therebetween. The barrier 100 may include any suitable number of posts 110. For example, the barrier 100 may include just one post 110. In other embodiments, the barrier 100 may include additional posts 110, such as 2, 3, 4, 5, 10, 20, 30, 100, 1000, 10000, or more posts or any suitable number therebetween depending on the application. As will be described in more detail hereafter, the posts 110 may comprise any suitable components, including a housing, electronic and/or mechanical components, or any other suitable components.

The upper support beams 130 and the lower support beams 140 shown in FIG. 1 may also be of any suitable size, shape, length, or orientation. For example, in some embodiments, as shown in FIG. 1, the upper support beams 130 and the lower support beams 140 may extend between two posts 110. In some embodiments, the upper support beams 130 and lower support beams 140 may be coupled to the posts 110 and oriented perpendicular or orthogonal to the posts 110, as shown. In other embodiments, the support beams 130 and 140 may only be coupled to one post 110 and may extend away from the post 110 and terminate in a free floating or suspended position. In some embodiments, the support beams 130 and 140 may be oriented at any other suitable angle relative to the posts 110. For example, in an embodiment in which the barrier 110 is positioned on an inclined surface, the posts 110 may be positioned vertical or plumb and support beams 130 and 140 may be positioned roughly parallel to the incline of the surface. In such an embodiment, the slats may also be sized and shaped accordingly as will be understood by one of skill in the art. Like the posts 110 and as will be described in more detail hereafter, the support beams 130 and 140 may comprise any suitable components, including housings, electronic and/or mechanical components, or any other suitable components.

The slats 120 shown in FIG. 1 may be of any suitable size, shape, or orientation. For example, as shown in FIG. 1, the slats may be mechanically coupled to one side of the lower support member 140 and one side of the upper support member 130. In other embodiments, the slats 120 may only be mechanically coupled to either the upper support member 130 or the lower support member 140. In some embodiments, the slats 120 may be positioned vertically or parallel to the posts 110 as shown in FIG. 1. However, the slats 120 may be positioned in any orientation or at any angle relative to other components of the barrier 110, for example the posts may be oriented horizontally or parallel to the support beams 130 and 140, diagonally, or may be at different angles. In some embodiments, the slats 120 may all be positioned at the same angle relative to one another and other components of the barrier 100. In other embodiments, the slats 120 may be positioned at different angles relative to each other and other components of the barrier 110. As with the posts 110 and support member 130 and 140, the slats 120 may comprise any suitable components, including housings, electronic and/or mechanical components, or any other suitable components.

The components shown in FIG. 1, including the posts 110, the support members 130 and 140 and the slats 120, may be constructed of any suitable material. For example, the posts 110 the support members 130 and 140, and the slats 120 may be constructed of a wood material, a wood composite material, a plastic material, a plastic composite material, vinyl, any suitable metal such as various sheet metal materials, any suitable masonry material, carbon fiber, polylactic acid (PLA), fiberglass, thermoplastics including short fiber reinforced thermoplastics, polyvinyl chloride (PVC), cedar, any wood-plastic composite (WPC), or any other similar or suitable material. In a preferred embodiment, any of the above listed components may be constructed of PVC.

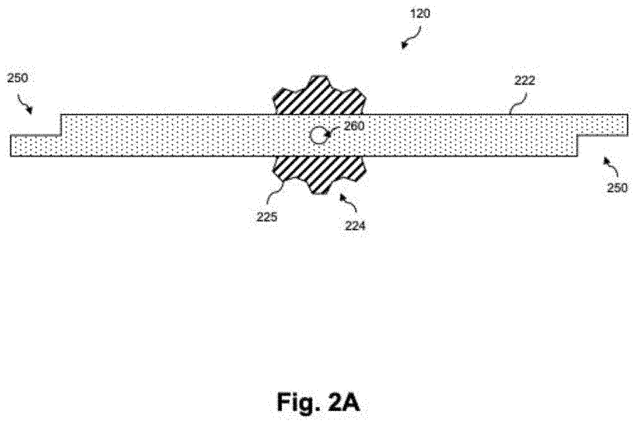

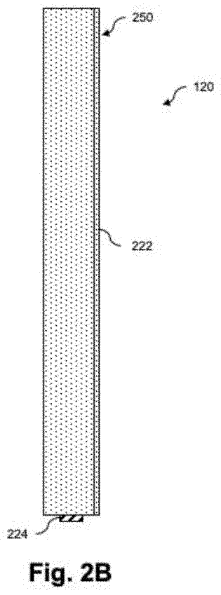

FIG. 2A is a diagrammatic top view of a slat 120, according to aspects of the present disclosure. The slat 120 shown in FIG. 2A may include various components or features including a panel 222, interlocking geometries 250, a cavity 260, and a sprocket 224 including a plurality of teeth 225.

The panel 222 shown in FIG. 2A may be of any suitable size or shape and may be constructed of any of the materials previously mentioned. For example, the width of the panel 222 may be of any suitable size including 1 mm, 2 mm, 3 mm, 1 cm, 2 cm, 3 cm, 1 m, 2 m, 3 m, or more or any suitable size between those listed. The depth of the panel 222 may also be of any suitable size including those listed, but in a preferred embodiment may be less than the width of the panel 222.

The panels 222 may all be of the same size and shape or may differ. In some embodiments, panels 222 may include interlocking geometries 250. As shown in FIG. 2A, the interlocking geometries 250 may be sized and shaped to fit into one another. In other words, one end of a panel 222 may be configured to receive the opposite end of an adjacent panel 222. The interlocking geometries 250 shown in FIG. 2A may be the same on both sides of the panel 222 or may differ. The interlocking geometries 250 may be or include a protrusion extending in one direction along one side of the panel 222, leaving a recessed portion, and a similar protrusion extending in an opposite direction along the other side of the panel 222 leaving a similar recessed portion. In other embodiments, however, the interlocking geometries 250 may be of any suitable shape. For example, they may include any suitable curvilinear segment. In other embodiments, the interlocking geometries may include additional teeth, grooves, recesses, protrusions, or any other suitable geometries configured to fit into one another or be received into one another.

Each panel 222 may be coupled to a sprocket 224. The sprocket 224 may be mechanically coupled to the panel 222 by any suitable means. For example, the sprocket 224 may be coupled to the panel with a screw, a plurality of screws, nails, adhesive, or any other suitable means. In addition, the sprocket 224 may be positioned perpendicular to the panel 222 as shown in FIG. 2A. In some embodiments, each panel 222 may not be coupled to a sprocket 224.

The sprocket 224 may be substantially circular in shape and may include a plurality of teeth 225. The teeth 225 of the sprocket 224 may be configured to receive a flexible elongate member, such as a chain. In some embodiments, the teeth 225 may fit within the grooves or holes of a belt or chain or any other suitable component. The teeth 225 may additionally be referred to as cogs, protrusions, or any other suitable term. The sprocket 224 may additionally be referred to as a gear, a cog, or any other suitable term.

The panel 222 may additionally include a cavity 260 as shown in FIG. 2A. The cavity 260 may extend completely through the panel 222 as shown and may extend lengthwise along the panel 222. In some embodiments, however, the cavity 260 may not extend completely through the panel 222 but may be a recess of limited depth. For example, one recess may be positioned at the top of the panel 222 and an additional recess may be positioned at a similar location at the bottom of the panel 222. The cavity 260 may be of any suitable dimension. For example, the cavity 260 may be of any suitable cross-sectional shape such as a circle as shown in FIG. 2A, or a square, triangle, pentagon, hexagon, or any other suitable geometric or non-geometric shape. In an embodiment in which the cavity 260 is of a circular cross-sectional diameter, the diameter of the cavity 260 may be any suitable size. For example, the diameter of the cavity 260 may be any size between 1 mm and any size less than the depth of the panel 222. The cavity 260 may additionally be positioned at any location within or on panel 222. For example, the embodiment shown in FIG. 2A shows the cavity 260 positioned at the center of the panel 222 or along the center axis of the panel 222 longitudinally. However, the cavity 260 may be positioned at any other suitable location off the center axis. In some embodiments, the cavity 260 may be configured to receive an additional component. For example, an elongate device or component may pass completely through the cavity 260. In an embodiment in which the cavity 260 is replaced with two recesses on either longitudinal end of the panel 222, the recess may receive protrusions of other components.

The sprocket 224 may additionally include a cavity similar to the cavity 260 of the panel 222. The sprocket 224 may be generally positioned at a location coupled to the panel 222 such that a straight, elongate member may pass through the cavity 260 as well as the cavity of the sprocket 224 as shown in FIG. 2A. It is additionally noted that in some embodiments, the sprocket 224 may part of the same unitary structure as the panel 222.

FIG. 2B is a diagrammatic side view of the slat 120 of FIG. 2A, according to aspects of the present disclosure. Shown in FIG. 2B is the panel 222 including the interlocking geometries 250 shown on one side and the sprocket 224.

In some embodiments, the interlocking geometries 250 discussed with reference to FIG. 2B may be configured such that when multiple panels 222 are positioned adjacent next to another and when interlocking geometries 250 are received into one another, the geometries 250 are not visible. Specifically, a single straight seam between panels 222 may be visible. In such a configuration, as shown in FIG. 2B, interlocking geometries 250 are visible only on one side of the panel 222. In other embodiments, interlocking geometries 250 may be visible when panels 222 are positioned directly adjacent to one another. In some embodiments, in a side view of a single panel 222, interlocking geometries 250 may be visible.

Additionally shown in FIG. 2B is the sprocket 224. It is noted that the sprocket 224 may be positioned at the bottom of the panel 222 as shown in FIG. 2B or may alternatively be positioned at the top of the panel 222. As mentioned, although the sprocket is positioned along the center axis of the panel 222, it may be positioned at any suitable location along the top or bottom of the panel 222. For example, the sprocket 224 may be positioned at any suitable location to the left or to the right of the location of the sprocket 224 shown in FIG. 2B. As will be discussed in more detail hereafter, there may also be a sprocket 224 positioned at the bottom of the panel 222 and an additional sprocket 224 positioned at the top of the panel 222 such that the panel 222 is coupled to two sprockets 224.

In still other embodiments, the panel may be coupled to additional sprockets 224. The panel 222 may be divided into multiple other panels such that sprockets 224 may be positioned between panels as well. In some embodiments, this configuration may allow a panel 222 to be longer than would ordinarily be possible by providing additional support for the weight of the panels. This embodiment may be suitable for unusually large barriers 100.

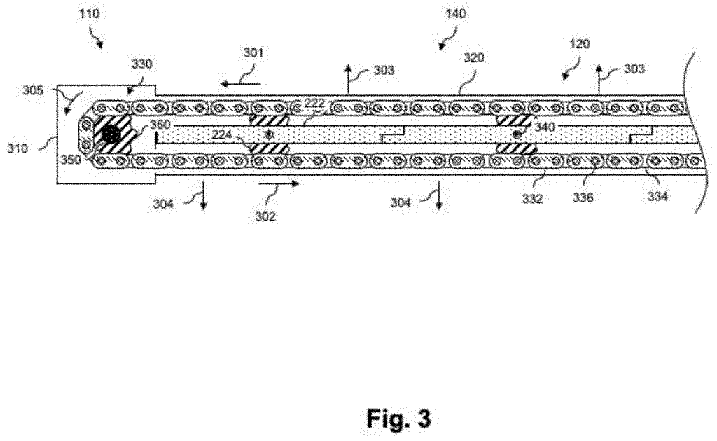

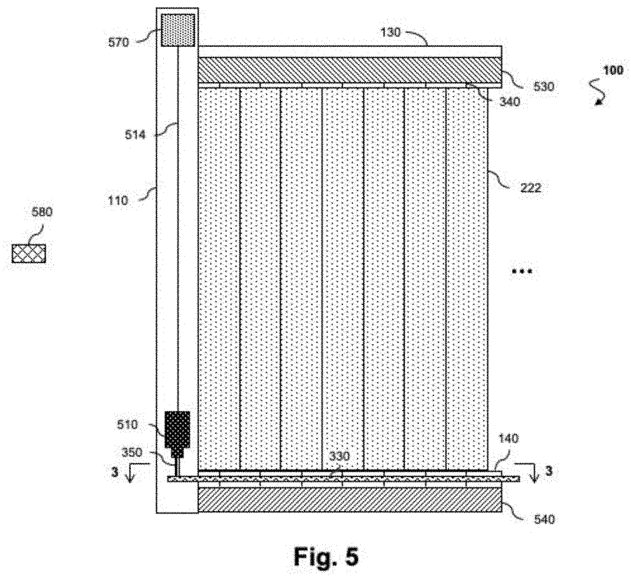

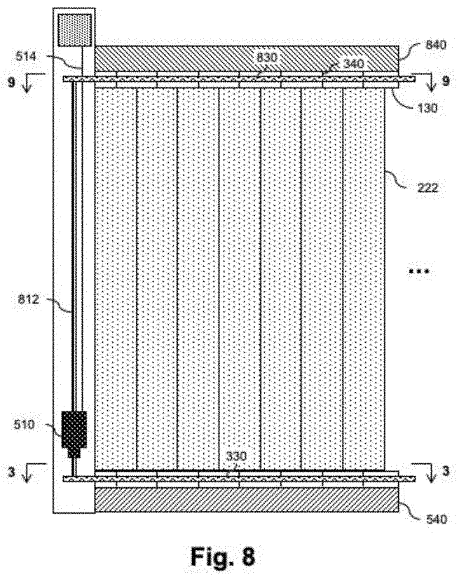

FIG. 3 is a diagrammatic cross-sectional top view of a section of a barrier 100 in a closed position, according to aspects of the present disclosure. FIG. 3 may depict one aspect of a means of rotating the slats 120 shown previously. FIG. 3 is a cross-sectional view taken along section line 3-3 hereafter shown in FIG. 5 and FIG. 8. FIG. 3 includes a cross-sectional top view of a post 110 and a lower support member 140. The post 110 may additionally include a housing 310 and a sprocket 360 mechanically coupled to a shaft 350. The lower support member 140 may additionally include a housing 320, a plurality of slats 120 shown previously including panels 222 and sprockets 224 and pivot rods 340. A flexible elongate member or chain 330 is additionally depicted including links 332, links 334, and pins 336. The combination of sprockets, a chain, a driving mechanism as will be discussed hereafter, and various other components shown in FIG. 3 may be referred to as a driving assembly. In other embodiments shown throughout this application, any combination of components or devices configured to rotate the slats 120 of the barrier 100 may also be referred to as a driving assembly regardless of the devices or methods used to achieve this purpose.

The post 110 shown in FIG. 3 may include a housing 310. In other embodiments, the post 110 may be a solid post such that no components are situated within the post 110. However, as shown in FIG. 3, multiple components are shown within the housing 310 of the post 110. The sprocket 360 may be positioned along the center axis of the post 110 or may be positioned at any other location within the housing 310. The sprocket 360 may be mechanically coupled to a supporting component allowing the sprocket 360 to rotate. The sprocket 360 may be substantially similar to the sprockets 224 previously described. Specifically, the sprocket 360 may be of any suitable shape, width, or diameter. The sprocket 360 may include a plurality of teeth similar to the teeth 225 of sprockets 224 (FIG. 2A).

The sprocket 360 may be mechanically coupled to a shaft 350. The shaft 350 may be coupled to the sprocket 360 in such a way that as the sprocket is rotated around a center axis, the attached shaft 350 also rotates around the same axis at the same rate of revolution. The shaft 350 may extend upward along the post 110 or downward and may be coupled to various other components within the post 110. In some embodiments, and as will be shown and described hereafter, the shaft 350 may be coupled to a driving mechanism such as an electric motor or handle that may be manually turned.

Additionally shown in FIG. 3 is the chain 330. The chain 330 may be of any suitable type and may be of any suitable material. In an exemplary and non-limiting aspect, the chain in FIG. 3 includes a plurality of links 332 and links 334. A link 332 may include two substantially flat components positioned parallel to one another with corresponding cavities in each. A link 334 may be substantially similar to the links 332 but the two flat components may be spaced at a shorter distance from one another such that links 334 may be received within the inner cavity created by links 332. Both links 332 and links 334 may additionally include a plurality of cavities configured to receive pins 336. Pins 336 may be substantially cylindrical in shape and may be positioned within the cavities of links 332 and 334 so as to connect the links together but allow the links to pivot at the location of the pins 336 in one direction or axis, but not in another. In some embodiments, the pins 336 may additionally be referred to as rollers, rods, cylinders, links, or any other suitable terms.

The teeth of the sprocket 360 may be configured to be received within corresponding spaces within the chain 330. For example, a single tooth of the sprocket 360 may be received between two pins 336. The spacing between teeth of the sprocket 360 may correspond to the spacing between two pins 336 of the chain 330.

Sprockets 224 of slats 120 may be similar to the sprocket 360 in that the teeth 225 of the sprockets 224 may also be configured to be received within corresponding spaces within the chain 330. For example, a single tooth 225 of a sprocket 224 may be received between two pins 336. The spacing between teeth of the sprocket 224 may, therefore, correspond to the spacing between two pins 336 of the chain 330.

As shown in FIG. 3, as the sprocket 360 is turned in a direction shown by the arrow 305, the top side of the chain 330 as shown in FIG. 3 is moved in a direction shown by the arrow 301. Similarly, the bottom side of the chain 330 shown is moved in a direction shown by the arrow 302. As the links on the top side of the chain 330 are moved in the direction of the arrow 301, the pins 336 of the chain 330 engage the teeth 225 of the sprockets 224. Similarly, the pins 336 of the bottom side of the chain 330 also engage the teeth 225 on the opposite side of the sprockets 224. This engagement of pins 336 of the chain 330 and teeth 225 of the sprockets 224 cause the sprockets 224 to rotate counter clockwise. As the sprockets 224 rotate counterclockwise, the panels 222 coupled to the sprockets 224 of the slats also rotate counterclockwise as shown by the arrows 303 and 304. As the panels 222 rotate, the interlocking geometries 250 of the panels 222 are moved out of contact with one another. The slats 120 then may rotate to any suitable angle with respect to the barrier 100 and may increase visibility through the barrier 100 or may serve to accomplish any of the purposes previously described.

Although the configuration shown and described with reference to FIG. 3 rotates the slats 120 in a counterclockwise manner to an open position, the same principles may be applied to construct an embodiment of the barrier 100 that rotates the slats in a clockwise manner to an open position. For example, the sprocket 360 may be rotated clockwise causing the slats 120 to rotate clockwise. The panels 222 of the slats 120 may also be configured with interlocking geometries 250 in an opposite direction to allow the panels to engage and disengage in the opposite direction.

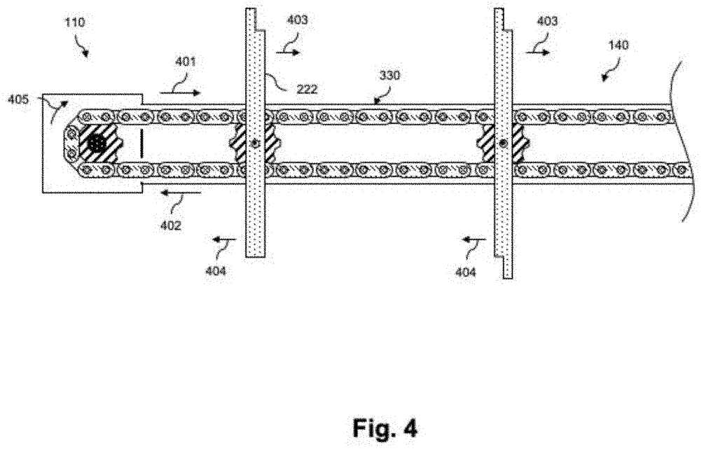

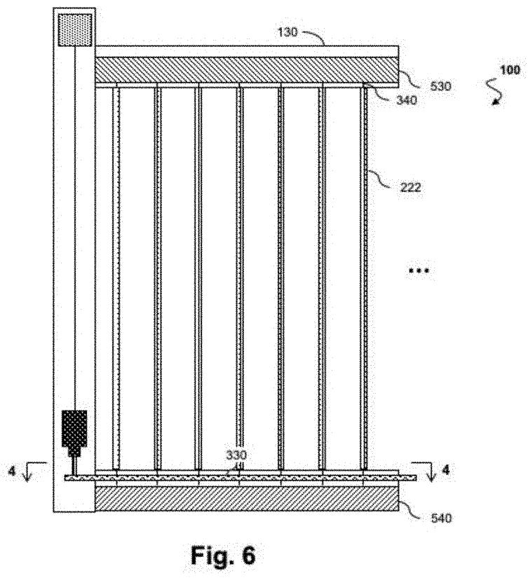

FIG. 4 is a diagrammatic cross-sectional top view of a section of a barrier 100 in an open position, according to aspects of the present disclosure. FIG. 4 is a cross-sectional view taken along section line 4-4 of FIG. 6. In an open position, the panels 222 of the slats 120 may be positioned substantially perpendicular to the direction of the barrier 100 as shown by the arrow 401. In other embodiments, however, the panels 222 may be positioned at any suitable angle relative to the direction of the barrier 100 as shown by the arrow 401 allowing varying levels of visibility through the barrier 100. For example, the panels 222 may be positioned at any angle between 0 degrees and a maximum angle. In the present embodiment, 0 degrees may correspond to the fully closed position shown in FIG. 3, 90 degrees may correspond to a perpendicular angle shown in FIG. 4, and a maximum angle may be determined by the angle at which panels 222 are again brought into contact with one another. In some embodiments, the maximum angle of the panels 222 may be limited to an angle of about 170 degrees such that panels 222 do not come into contact with one another by rotating more than 170 degrees. This maximum angle may be more or less than 170 degrees depending on the geometry of the panels 222 or other factors.

To bring the panels 222 of the slats 120 back into a closed positioned, like the one shown in FIG. 3, the sprocket 360 may be turned clockwise as shown by the arrow 405. As shown in FIG. 4, as the sprocket 360 is turned clockwise, the top side of the chain 330 as shown in FIG. 4 is moved in a direction shown by the arrow 401. Similarly, the bottom side of the chain 330 shown is moved in a direction shown by the arrow 402. As the links on the top side of the chain 330 are moved in the direction of the arrow 401, the pins 336 of the chain 330 engage the teeth 225 of the sprockets 224. Similarly, the pins 336 of the bottom side of the chain 330 also engage the teeth 225 on the opposite side of the sprockets 224. This engagement of pins 336 of the chain 330 and teeth 225 of the sprockets 224 cause the sprockets 224 to rotate clockwise. As the sprockets 224 rotate clockwise, the panels 222 coupled to the sprockets 224 of the slats also rotate clockwise as shown by the arrows 403 and 404. As the panels 222 continue to rotate until the panels 222 are brought to an angle of 0 degrees again, the interlocking geometries 250 of the panels 222 are moved into contact with one another. The slats 120 then prevent all visibility through the barrier 100 or may serve to accomplish any of the purposes previously described.

In some embodiments, the chain 330, the sprockets 224 and the sprocket 360 are not visible to a user of the barrier 100. For example, these components, as well as any other suitable components, including components of the chain 330, or other components, may be enclosed within any suitable housing within the barrier 100. For example, components may be housed within the housing 310 (FIG. 3) or the housing 320 (FIG. 3). In some embodiments, the chain 330 and the sprockets 224 and 360 may also be housed in a housing of the upper support beam 130. The barrier 100 may additionally include any suitable components which may aid in the movement or stabilization of the chain 330. For example, the barrier 100 may include a track or a narrow passageway or recess through which the chain 330 may pass. In this way, the chain 330 may be kept in generally the same location or position relative to the slats 120 and importantly to the sprockets 224 and 360 such that the chain 330 may maintain constant and consistent contact with the sprockets 224 and 360 at all times. In some embodiments, a lubricant of any suitable type may be introduced to the chain 330 and/or the sprockets 224 and 360 to enable or enhance mobility of various components of the chain 330 and/or the sprockets 224 and 360.

It is also noted that the chain 330 and the sprockets 224 and 360 may be constructed of any suitable material and may be of any suitable type. For example, the components of the chain 330 may be constructed of a metallic material such as carbon, steel, alloy steel, stainless steel, iron, brass, copper, bronze, ductile iron, aluminum, titanium, or non-metallic material such as polycarbonate, any suitable polyethylene compound, PVC, polypropylene, polystyrene, acrylic, acetal, acrylonitrile butadiene styrene, or any other suitable material. In some embodiments, the components of the barrier 100, such as but not limited to the chain 330 and the sprockets 224 and 360 may be constructed of or coated in a material to prevent rust, such as nickel.

FIG. 5 is a diagrammatic side view of a section of a barrier 100 in a closed position, according to aspects of the present disclosure. As shown, in a closed position, visibility through the barrier 100 may be completely or substantially limited. FIG. 5 depicts the post 110, the lower support beam 140, the upper support beam 130, and plurality of panels 222 of slats 120. The post 110 depicted additionally includes the shaft 350 attached to the sprocket 360, a driving mechanism 510, a connecting cable 514, and a user interface 570. The lower support beam 140 includes a support block 540. The upper support beam 130 includes a support block 530. The chain 330 is shown extending along and/or within the post 110 and lower support beam 140 and a plurality of pivot rods 340 are shown extending from the upper support beam 130 to the lower support beam 140 through the panels 222. FIG. 5 additionally depicts a transmitting device 580.

The driving mechanism 510 may be any suitable driving mechanism configured to turn the shaft 350 in both a clockwise and counterclockwise direction. As previously described, as the driving mechanism 510 turns the shaft 350, the shaft 350 being mechanically coupled to the sprocket 360, the chain 330 shown moves and engages the sprockets 224 causing the panels 224 to rotate in either a clockwise or counterclockwise direction. In some embodiments, the sprocket 360 may be directly coupled to the driving mechanism 510. In other embodiments, the sprocket 360 and shaft 350 may be one unitary structure that is mechanically coupled to the driving mechanism 510.

In some embodiments, the driving mechanism 510 may be an electric motor. The driving mechanism 510 may be any suitable type of electric motor, including but not limited to an AC brushless motor, a DC brushed motor, a DC brushed motor, a DC shunt motor, a DC series motor, a separately excited motor, a permanent magnet DC motor, a DC compound motor, an induction motor, a direct drive motor, a linear motor, a servo motor, a stepper motor, or any other suitable type of electric motor. In some embodiments, the motor may be of any other suitable type, including but not limited to an internal combustion engine of any type, or any other suitable motor.

It is also noted, that although the driving mechanism 510 is shown positioned within the post 110 in FIG. 5, it may be positioned in any suitable location within or outside of the barrier 100. For example, the driving mechanism 510 may alternatively be positioned in the lower support beam 140 or within its housing, in the upper support beam 130 or within its housing, or may be positioned adjacent to the barrier 100. In some embodiments, the driving mechanism 510 may be positioned adjacent to the post 110 within a separate housing but mechanically coupled to the sprocket 360. As will be obvious to one of ordinary skill in the art, the sprocket 360 and/or shaft 350 may also be positioned in any of the locations in which the driving mechanism 510 may be positioned. In addition, additional sprockets, shafts, or chains may be included to transfer rotating power from the driving mechanism to the appropriate sprockets 224 to rotate the panels 222.

The barrier may additionally include a user interface 570 similar to the one shown in FIG. 5. The user interface 570 may be configured to receive inputs from a user and generate commands for the driving mechanism 510 causing the driving mechanism 510 to turn. In some embodiments, the driving mechanism 510 may receive user inputs by any suitable means. For example, the driving mechanism 510 may receive user inputs via one or more buttons positioned on or within the user interface 570. In other embodiments, the user interface 570 may include a touch screen device configured to detect a touch gestures from a user. In some embodiments, the user interface 570 may detect motion as an input, may detect sounds of any suitable type as an input, or may receive a user input in any other suitable way. In some embodiments, the user interface may additionally include a processor circuit including a processor, a memory storing instructions, and a communication module.

In some embodiments, the user interface 570 may be configured to generate and send commands to the driving mechanism 510 according to a preset timing schedule. The timing schedule may be determined by a user of the barrier 100. In other embodiments, the user interface 570 may be additionally be configured by any means, for example, through the communication module, to detect amounts of light such that when the threshold of light is reached, a signal or command is sent to the driving mechanism 510 to open or close the panels 222 of the barrier 100. Similarly, when an amount of light falls below the threshold, a command may be sent to the driving mechanism 510 to open or close the panels 222. In some embodiments, a user may determine the threshold of light as a unit of lumens or by any other suitable means.

FIG. 5 also depicts the connecting cable 514. The connecting cable 514 may be in communication with the user interface 570 and the driving mechanism 510. The connecting cable 514 may serve multiple functions and may include various conductors. For example, the connecting cable 514 may include a signal cable configured to transmit and receive signals to and from the driving mechanism 510. The signal cable may be of any suitable type, shape, length, or material. For example, the signal cable may be a single conductor, a braided cable, a twisted pair, or any other suitable cable. The signal cable and any other cables within the connecting cable 514 may be constructed of any suitable conductive material. A power cable may additionally extend from the user interface 570 and the driving mechanism 510. In some embodiments, the driving mechanism 510 may receive power through this cable of the connecting cable 514. In other embodiments, the driving mechanism 510 may receive power via a separate cable which may be connected to a power source, such as a traditional residential power line, or any other suitable power source. The user interface 570 may additionally be in communication with a power cable transferring necessary power from a similar source.

In other embodiments, both the driving mechanism 510 and the user interface 570 may be receive power from a battery positioned at any suitable location within or without the barrier 100. For example, a battery may be positioned within a post 110, within the same post 110 as the driving mechanism 510 and/or user interface 570, within any support beam 130 or 140, or any other suitable component of the barrier 100. In some embodiments, the battery may be in communication with any suitable forms of electricity generation, such as but not limited to solar panels, wind turbines, hydroelectric energy sources, or any other suitable source.

In an embodiment in which the battery described is in communication with and powered by one or more solar panels, the solar panels may be positioned on any suitable location on the barrier 100. For example, the solar panels may be positioned on the outer surface of a post 110 on any suitable side or on the top of a post 110. The solar panels may additionally be positioned on the top of an upper support beam 130, on the sides of an upper support beam 130, or on the top or sides of the lower support beam 140. In some embodiments, the solar panels may be positioned on the outer surfaces of the panels 222 of the slats 120. In still other embodiments, the solar panels may be positioned at some distance from the barrier 100 and one or more cables may be positioned between the barrier 100 and the solar panels bringing the two in electrical communication and providing power to the driving mechanism 510, user interface 570, and/or any other suitable components of the barrier 100. In other embodiments, components for receiving and/or generating electrical power of any other type may be positioned at these same locations.

In some embodiments, and as shown in FIG. 5, the barrier 100 may be a system including a transmitting device 580. The transmitting device 580 may be any suitable transmitting device and may transmit signals to and from the user interface 570 of the barrier 100 either wirelessly or through a wired connection. In some embodiments, the transmitting device 580 may include a single button. A user of the device may depress the button of the transmitting device 580 to open or close the panels 222 of the barrier 100. For example, upon the pressing of the button of the transmitting device 580, the device 580 may send a wireless signal to the user interface 570 of the barrier 510 which may in turn cause a signal to be sent from the user interface 570 to the driving mechanism 510 to rotate the slats 120 to a desired position. In other embodiments, the transmitting device 580 may include additional buttons, including buttons configured to allow a user to set a timing schedule of times of day at which the user wishes the barrier 100 to be in an open position or in a closed position. Additional buttons may perform any other suitable function like resetting the system, clearing or entering data, or any other function. In still other embodiments, the transmitting device 580 may be a smart device, such as a cell phone, tablet, or computer. The transmitting device 580 may utilize a software application to communicate with or send signals to and from the user interface 570. For example, the transmitting device 580 may establish a communicative connection with the user interface 570 via an IEEE 802.11b direct sequence (Wi-Fi) or Bluetooth® connection. The transmitting device 580 may receive user inputs via any suitable means, such as via one or more buttons, a touch screen, a mouse, a keyboard, or any other suitable means of user input.

As shown in FIG. 5, the lower support beam 140 may include a support block 540. In some embodiments, the support block 540 may be positioned within the housing of the lower support beam 140 and may be mechanically coupled to the pivot rods 340 pictured. The pivot rods 340 may be mounted within or otherwise mechanically bonded to the support block 540 by any suitable means. The support block 540 may be constructed of any suitable material including any material having sufficient rigidity to support the weight of the pivot rods 340 and slats 120. Similar support blocks of various sizes, shapes, weights, geometries, or other features may additionally be positioned within or around any other component within the barrier 100.

The support block 530 may be substantially similar to the support block 540 in that it may be mechanically connected to the pivot rods 340. In other aspects, the support block 530 may differ from the support block 540. For example, the support block 530 may be positioned within the upper support beam 130.

The pivot rods 340 shown in FIG. 5 and previously described with reference to FIG. 3 and FIG. 4 may extend longitudinally through the panels 222 of the slats 120. The pivot rods 340 may be configured to allow the slats 120 to rotate around an axis as the driving mechanism 510 turns the chain 330 and in turn causes the slats 120 to rotate.

FIG. 6 is a diagrammatic side view of a section of a barrier 100 in an open position, according to aspects of the present disclosure. Similar to the position shown and described with reference to FIG. 4, in an open position, the panels 222 of the slats 120 may be rotated in such a way that they are substantially perpendicular to the upper and lower support beams 130 and 140 or the general longitudinal direction of the barrier 100. In an open position, the barrier 100 may allow increased visibility through the barrier 100 as well as serve other purposes as previously stated. In other embodiments, the panels 222 may be set to any suitable position or angle with respect the barrier 100 so as to modify the visibility, air or water flow, or otherwise modify the position and/or purpose of the barrier 100.

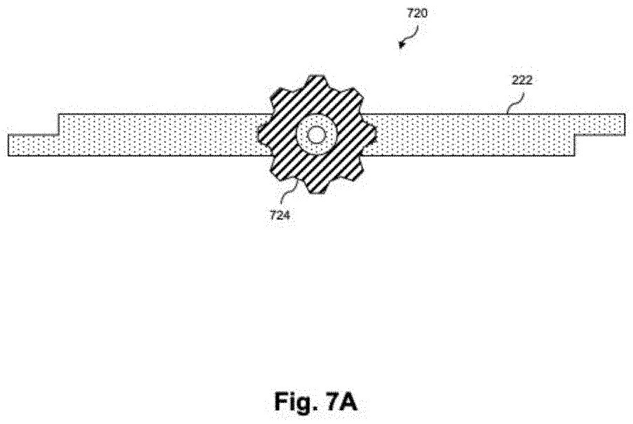

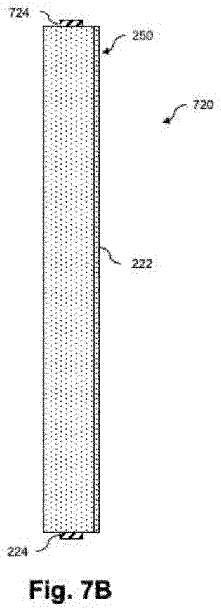

FIG. 7A is a diagrammatic top view of a slat 720, according to aspects of the present disclosure. In some embodiments, as shown in FIGS. 7A-9, multiple chains may be implemented within the barrier 100 and mechanically coupled to the panels 222 so as to increase the points of contact between the driving mechanism 510 and the panels 222 of the slats 120. This embodiment may result in an increased ability of the driving mechanism 510 to turn the panels 222 of the slats 120 resulting in conservation of energy and increased rigidity or ability of the barrier 100 in general to withstand the elements of the outdoors or any other conditions of the surrounding environment.

The slat 720 shown in FIG. 7A may be substantially similar to the slat 120 of FIG. 2A. However, the slat 720 may include an additional sprocket 724 mechanically coupled to the slat 720 at the top end. In some embodiments, the slat 720 may still include the sprocket 224 at the bottom end of the slat 720 like the slat 120 shown in FIG. 2A. In other embodiments, the slat 720 may only include sprocket 724 at the top end. As mentioned with reference to the slat 120, the sprocket 724 may be the same unitary structure as the panel 222 or the two components may be coupled together. Additionally, sprocket 224, sprocket 724 and the panel 222 may also be one unitary structure or may they may be separate structures mechanically bonded together. The sprocket 724 may be constructed of any material or in any manner the same or similar to the sprocket 224 previously described.

FIG. 7B is a diagrammatic side view of the slat 720 of FIG. 7A, according to aspects of the present disclosure. Shown in FIG. 7B is the panel 222 including the interlocking geometries 250 shown on one side, the sprocket 224, and the sprocket 724. The interlocking geometries 250 may include any of the same features or characteristics as the interlocking geometries 250 previously discussed with reference to FIGS. 2A and 2B. As previously mentioned with reference to the sprocket 224, although the sprocket 724 is positioned along the center axis of the panel 222, it may be positioned at any suitable location along the top of the panel 222. For example, the sprocket 724 may be positioned at any suitable location to the left or to the right of the location of the sprocket 724 shown in FIG. 7B.

FIG. 8 is a diagrammatic side view of a section of a barrier 100 with an electric motor 510 coupled to two flexible elongate members 330 and 830, according to aspects of the present disclosure. The section of the barrier 100 shown in FIG. 8 may include similar components and features as previous figures. However, FIG. 8 additionally depicts a shaft 812, an additional chain 830, and a support block 840.

The shaft 812 may be similar to the shaft 350 previously described. However, shaft 812 may differ in that the shaft 812 may extend from either side of the driving mechanism 510 and be mechanically bonded to sprockets at either end. For example, at the bottom end, the shaft 812 may be mechanically bonded to the sprocket 360 previously described. At the top end, the shaft 812 may be mechanically bonded to an additional sprocket in connection with the additional chain 830. In this way, as the driving mechanism turns the shaft 812, the shaft 812 may turn both the sprocket 360 and the additional sprocket at the top end at the same rate and cause them to turn together.

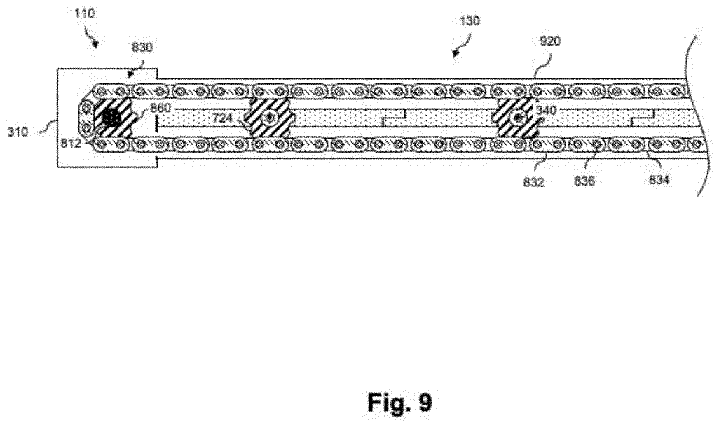

The additional chain 830 shown in FIG. 8 may be substantially similar to the chain 330 shown in FIG. 8 and previously described. Because both the chain 330 and the chain 830 are in connection with the rotating shaft 812 through the sprocket 360 and the additional sprocket to be described with reference to FIG. 9, the chains 330 and 830 may move at the same rate.

FIG. 9 is a diagrammatic cross-sectional top view of a section of a barrier 100, according to aspects of the present disclosure. FIG. 9 may depict one aspect of a means of rotating the slats 120 shown previously. FIG. 9 is a cross-sectional view taken along section line 9-9 shown in FIG. 8. FIG. 9 includes a cross-sectional top view of a post 110 and an upper support member 130. The post 110 may additionally include a housing 310 and the additional sprocket 860 described with reference to FIG. 8 mechanically coupled to the shaft 812. The upper support member 130 may additionally include a housing 920, a plurality of slats 120 shown previously including panels 222 and sprockets 724 and pivot rods 340. An additional flexible elongate member or chain 830 is additionally depicted including links 832, links 834, and pins 836.

As previously described with reference to FIG. 3, the post 110 shown in FIG. 8 may include a housing 310 or may include any features or characteristics previously mentioned. The sprocket 860 may be positioned along the center axis of the post 110 or may be positioned at any other location within the housing 310. The sprocket 860 may be mechanically coupled to a supporting component allowing the sprocket 860 to rotate. The sprocket 860 may be substantially similar to the sprocket 360 and/or the sprockets 224 previously described. Specifically, the sprocket 860 may be of any suitable shape, width, or diameter. The sprocket 860 may include a plurality of teeth 725 similar to the teeth 225 of sprockets 224 (FIG. 2A).

The sprocket 860 may be mechanically coupled to the shaft 812. The shaft 812 may be coupled to the sprocket 860 and the sprocket 360 in such a way that as the sprockets 860 and 360 is rotated around a center axis, the attached shaft 812 also rotates around the same axis at the same rate of revolution. The shaft 812 may extend upward along the post 110 or downward and may be coupled to various other components within the post 110. In some embodiments, and as will be shown and described hereafter, the shaft 812 may be coupled to a driving mechanism such as an electric motor or handle that may be manually turned.

Additionally shown in FIG. 9 is the chain 830. The chain 830 may be substantially similar to the chain 330. The chain 830 may be of any suitable type and may be of any suitable material. In an exemplary and non-limiting aspect, the chain 830 in FIG. 8 includes a plurality of links 832, links 834, and pins 836. The links 832 may be substantially similar to the links 332. The links 834 may be substantially similar to the links 334. The pins 836 may be substantially similar to the pins 336.

The teeth of the sprocket 860 may be configured to be received within corresponding spaces within the chain 830. For example, a single tooth of the sprocket 860 may be received between two pins 836. The spacing between teeth of the sprocket 860 may correspond to the spacing between two pins 836 of the chain 830. Sprockets 724 of slats 120 may be similar to the sprocket 860 in that the teeth 725 of the sprockets 724 may also be configured to be received within corresponding spaces within the chain 830.

As shown in FIG. 8, as the sprocket 860 is turned, the chain 830 is moved in a similar direction. As the links of the chain 830 are moved, the pins 836 of the chain 830 engage the teeth 725 of the sprockets 724. This engagement of pins 836 of the chain 830 and teeth 725 of the sprockets 724 cause the sprockets 724 to rotate. As the sprockets 724 rotate, the panels 222 coupled to the sprockets 724 of the slats also rotate. As the panels 222 rotate, the interlocking geometries 250 of the panels 222 are moved out of contact with one another. The slats 120 then may rotate to any suitable angle with respect to the barrier 100 and may increase visibility through the barrier 100 or may serve to accomplish any of the purposes previously described. As previously mentioned, the sprocket 360 may rotate with the sprocket 860 causing the chain 330 to move as previously described at the same time and in the same manner as the chain 830 causing the slats 120 to be rotate and/or driven at at least two points of contact including at a top portion and at a bottom portion.

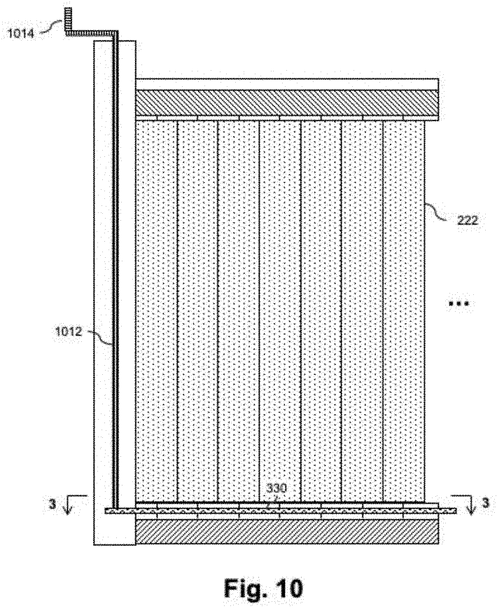

FIG. 10 is a diagrammatic side view of a section of a barrier 100 with a manual driving mechanism, according to aspects of the present disclosure. The section of the barrier 100 shown in FIG. 10 may include similar components and features as previous figures. However, FIG. 10 depicts a shaft 1012, and a handle 1014.

The shaft 1012 may also be referred to as a driving mechanism. In some embodiments, the shaft 1012 may replace the driving mechanism 510, user interface 570, and other connected components previously described with reference to FIG. 5. The shaft 1012 may be mechanically coupled to the sprocket 360 shown previously. The shaft 1012 may be configured to be rotated manually by a user of the barrier 100 rather than by the driving mechanism 510. The shaft 1012 may be connected to a rotating handle 1014. In some applications, a user of the barrier 100 may grasp the rotating handle 1014 and turn the handle 1014 in a circular manner. As the rotating handle 1014 is turned, it may turn the shaft 1012 which may rotate the sprocket 360. As the sprocket 360 rotates, the panels 222 of slats 120 may rotate between various open positions and a closed position as previously described. In some embodiments, the sprocket 360 and the shaft 1012 may be one unitary structure or may be multiple structures mechanically bonded together.

In the embodiment shown in FIG. 10, less components are required for proper operation of the barrier 100. This may lead to decreased manufacturing costs and complexity and a more affordable end product. In addition, the embodiment shown in FIG. 10 does not require a power source allowing for operation of the barrier 100 in an increased variety of locations and environments.

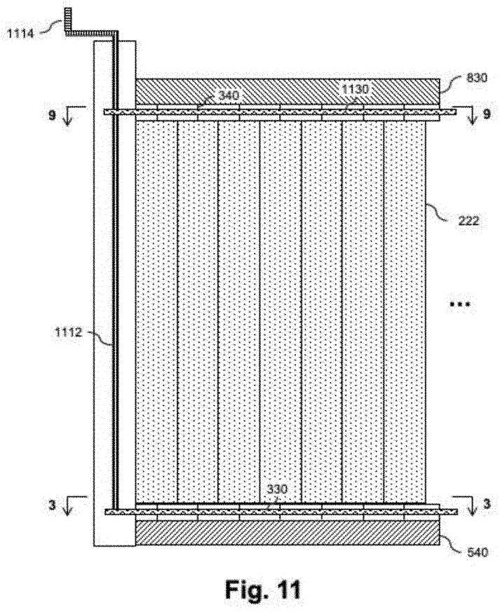

FIG. 11 is a diagrammatic side view of a section of a barrier 100 with a manual driving mechanism coupled to two flexible elongate members 330 and 1130, according to aspects of the present disclosure. The section of the barrier 100 shown in FIG. 11 may include similar components and features as previous figures. However, FIG. 11 depicts a shaft 1112, a handle 1114, and an additional chain 1130.

The shaft 1112 may be similar to the shaft 1012 of FIG. 10. The shaft 1112 may also be referred to as a driving mechanism. In some embodiments, the shaft 1112 may replace the driving mechanism 510 and associated components and/or the shaft 1012. The shaft 1112 may be mechanically coupled to both the sprocket 360 shown previously and an additional sprocket 860 of FIG. 9. The shaft 1112 may be configured to be rotated manually by a user of the barrier 100 and may be connected to a rotating handle 1114. In some applications, a user of the barrier 100 may grasp the rotating handle 1114 and turn the handle 1114 in a circular manner like the handle 1014 previously described. As the rotating handle 1114 is turned, it may turn the shaft 1112 which may rotate the sprocket 360 and the sprocket 860. As the sprockets 360 and 860 rotate, the chains 830 and the chain 1130 may move in a similar direction. The chain 1130 may be substantially similar to the chain 830. As the chains 330 and 1130 move, the panels 222 of slats 120 may rotate between various open positions and a closed position as previously described. In some embodiments, the sprockets 360 and 860 and the shaft 1112 may be one unitary structure or may be multiple structures mechanically bonded together. In the embodiment shown in FIG. 11, the panels 222 of the slats 120 may be driven at two points of contact similar to the configuration shown in FIG. 8.

In the embodiment shown in FIG. 11, less components are required for proper operation of the barrier 100. This may lead to decreased manufacturing costs and complexity and a more affordable end product. In addition, the embodiment shown in FIG. 11 does not require a power source allowing for operation of the barrier 100 in an increased variety of locations and environments. In some aspects, the embodiment shown in FIG. 11 may require more components than shown in FIG. 10, but may increase the strength and effectiveness of various components and/or functions within the barrier 100 similar to that described with reference to FIG. 8.

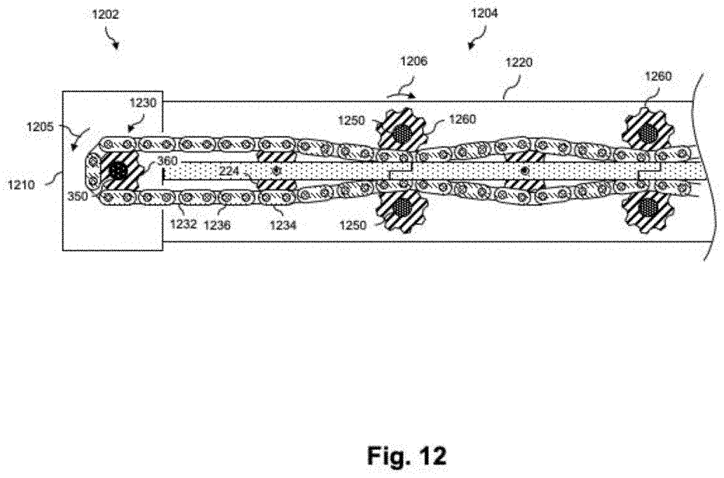

FIG. 12 is a diagrammatic cross-sectional top view of a section of a barrier 100, according to aspects of the present disclosure. FIG. 12 may depict aspects of an additional means of rotating the slats 120 shown previously. FIG. 12 is a cross-sectional view of an additional embodiment which may be taken along section line 3-3 shown in FIG. 5, FIG. 8, FIG. 10, and/or FIG. 11. FIG. 12 includes a cross-sectional top view of a post 1202 and a lower support member 1204. The post 1202 may additionally include a housing 1210 and the sprocket 360 mechanically coupled to a shaft 350. The lower support member 1204 may additionally include a housing 1220. A flexible elongate member or chain 1230 is additionally depicted including links 1232, links 1234, and pins 1236. FIG. 12 also depicts a plurality of additional sprockets 1260 and pivots 1250.

The post 1202 may substantially similar to the post 110 however may be of a difference geometry. The post 1202 shown in FIG. 12 may include a housing 1210. As previously described with reference to FIG. 3, the post 1202 may include any features or characteristics previously mentioned with reference with the post 110. The sprocket 360 and the shaft 350 may retain the same characteristics and features as well as positions or any other aspects as previously described.

Additionally shown in FIG. 12 is the chain 1230. The chain 830 may be substantially similar to the chain 330 and/or the chain 830 previously described. The chain 1230 may be of any suitable type and may be of any suitable material. In an exemplary and non-limiting aspect, the chain 1230 in FIG. 12 includes a plurality of links 1232, links 1234, and pins 1236. The links 1232 may be substantially similar to the links 332 and/or 832. The links 1234 may be substantially similar to the links 334 and/or 834. The pins 1236 may be substantially similar to the pins 336 and/or 836.

The teeth of the sprocket 360 may be configured to be received within corresponding spaces within the chain 1230. For example, a single tooth of the sprocket 360 may be received between two pins 1236. The spacing between teeth of the sprocket 360 may correspond to the spacing between two pins 1236 of the chain 1230. Sprockets 224 of slats 120 shown in FIG. 12 may be similar to the sprocket 360 in that the teeth 225 of the sprockets 224 may also be configured to be received within corresponding spaces within the chain 1230.

FIG. 12 additionally depicts the additional sprockets 1260. In some embodiments, the additional sprockets 1260 may be similar to the sprockets 224, 360, or any of the sprockets previously described. Additional sprockets 1260 may be substantially circular in shape and may include a plurality of teeth evenly distributed around the outer circumference of the sprockets 1260. The additional sprockets 1260 may be configured to rotate freely on a pivot rod 1250. The pivot rod 1250 may additionally be referred to as a pivot, pivot point, axis, rotating axis, or any other suitable terms. In some embodiments, the pivot rods 1250 may include ball bearings configured to enhance rotations and reduce friction of the sprockets 1260. Similar ball bearings may be use in the application of any other sprocket mentioned in the present disclosure.

In some embodiments, the additional sprockets 1260 may be positioned such that while the sprockets 224 are in contact with an inner surface of the chain 1230, the additional sprockets 1260 are positioned to be in contact with the outer surface of the chain 1230. The Additional sprockets 1260 may be positioned between two sprockets 224 as shown. The additional sprockets 1260 may be positioned such that the chain 1230 does not lie in a straight line along its path as in FIG. 3, but such that the additional sprockets 1260 offset the path of the chain 1230. In this way, the additional sprockets 1260 may serve to provide additional points of contact between the sprockets 224 and the chain 1230 and provide a more reliable connection between the components.

As shown, as the sprocket 360 is turned in a direction shown by the arrow 1205, the sprockets 224 may turn in a similar direction. However, the additional sprockets 1260 may rotate in an opposite direction as shown by the arrow 1206.

In some embodiments, fewer additional sprockets 1260 may be implemented in the driving assembly shown. For example, additional sprockets 1260 may be positioned between every other pair of sprockets 224 such that from a point along the barrier 100 is positioned one sprocket 224, two additional sprockets 1260 on either side of the chain 1230, one sprocket 224 followed by another sprocket 224, then two additional sprockets 1260, and so on. Additional sprockets 1260 may also be placed in more scare increments. One additional sprocket 1260 may also be positioned on one side of the chain 1230 without an additional sprocket 1260 on the other. In some embodiments more additional sprockets 1260 may be positioned within the driving assembly including three, four, five, or more additional sprockets 1260 positioned between sprockets 224.

As shown in FIG. 12, as the sprocket 360 is turned in a direction shown by the arrow 1205, the chain 1230 is moved in in a similar direction. As the links of the chain 1230 are moved, the pins 1236 of the chain 1230 engage the teeth 225 of the sprockets 224. This engagement of pins 1236 of the chain 1230 and teeth 225 of the sprockets 224 cause the sprockets 224 to rotate. As the sprockets 224 rotate, the panels 222 coupled to the sprockets 224 of the slats also rotate. As the panels 222 rotate, the interlocking geometries 250 of the panels 222 are moved out of contact with one another. The slats 120 then may rotate to any suitable angle with respect to the barrier 100 and may increase visibility through the barrier 100 or may serve to accomplish any of the purposes previously described.

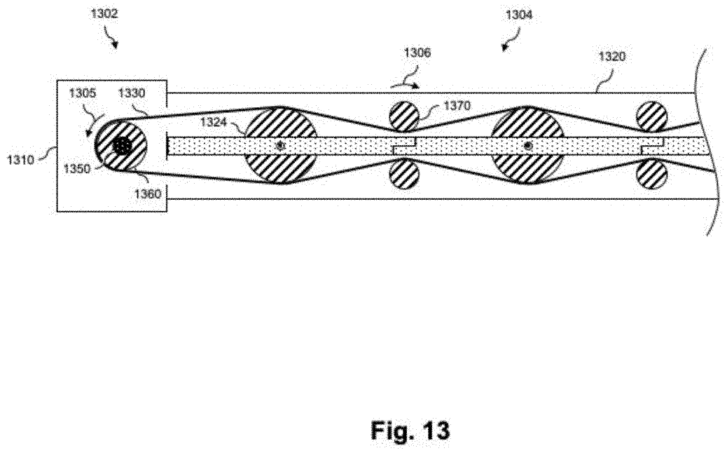

FIG. 13 is a diagrammatic cross-sectional top view of a section of a barrier 100, according to aspects of the present disclosure. FIG. 13 illustrates an alternative driving assembly or means of rotating the slats 120 of the barrier 100. FIG. 13 depicts a post 1302 including a housing 1310, a support beam 1304 including a housing 1320, a pulley 1360, a shaft 1350, a plurality of pulleys 1324, pulleys 1370, and a belt 1330.

The post 1302 shown in FIG. 13 may be substantially similar to the post 110 described previously. The post 1302 may include a housing 1310. In other embodiments, the post 1302 may be a solid post such that no components are situated within the post 1302. However, as shown in FIG. 13, multiple components are shown within the housing 1310 of the post 1302. The pulley 1360 may be positioned along the center axis of the post 1302 or may be positioned at any other location within the housing 1310. The pulley 1360 may be mechanically coupled to a supporting component allowing the pulley 1360 to rotate. The pulley 1360 may be of any suitable shape, width, or diameter. The pulley 1360 may be a substantially circular shape with a smooth outer surface configured to receive and drive a belt 1330 as will be discussed hereafter. In other embodiments, the pulley 1360 may include a plurality of teeth or ridges distributed around the outer surface of the pulley 1360.

The pulley 1360 may be mechanically coupled to a shaft 1350. The shaft 1350 may be coupled to the pulley 1360 in such a way that as the pulley is rotated around a center axis, the attached shaft 1350 also rotates around the same axis at the same rate of revolution. The shaft 1350 may extend upward along the post 1302 or downward and may be coupled to various other components within the post 1302 including a driving mechanism similar to the driving mechanism 510 or a manual driving mechanism similar to the shaft 1012 or shaft 1112 previously described.

Additionally shown in FIG. 13 is the belt 1330. The belt 1330 may be of any suitable type and may be of any suitable material. In an exemplary and non-limiting aspect, the belt 1330 in FIG. 13 may be constructed of a rubber material or rubber composite. In some embodiments, the belt 1330 may be constructed of a reinforced rubber material. In some embodiments, the belt may be substantially smooth on both an inner and outer surface. In other embodiments, at least one side of the belt may include ridges configured to receive teeth or ridges positioned on the outer surface of the pulley 1360 or any other pulley within the driving assembly. The dimensions of the belt 1330 may correspond to one or more dimensions of the pulley 1360 or other pulleys within the driving assembly. For example, the width of the pulley 1360 may be the same or similar to the width of the belt 1330.

Pulleys 1324 may be mechanically coupled to the panels 222 of the slats 120 and may be coupled in any suitable way including any of the coupling methods previously described with reference to sprockets 224. Additionally, the pulleys 1324 and the panels 222 may be one unitary structure. The pulleys 1324 may be similar to the pulley 1360. In some embodiments, the dimensions of the pulleys 1324 may vary from the dimensions of the pulley 1360. The pulleys 1324 may have a substantially smooth outer surface or may be include teeth or ridges as previously described with reference to the pulley 1360. These teeth or ridges may be configured to be received into corresponding teeth or ridges of the belt 1330.

Additionally shown in FIG. 13 is a plurality of pulleys 1370. In some embodiments, the pulleys 1370 may serve a similar purpose as the additional sprockets 1260 described with reference to FIG. 12. For example, the pulleys 1370 may be similar to the pulleys 1360, 1324 described. The pulleys 1370 may vary in dimensions. The pulleys 1370 may be substantially circular in shape and may be substantially smooth along an outer surface or may include a plurality of teeth or ridges distributed around the outer circumference of the pulleys 1370. The pulleys 1370 and any other pulleys described herein may be configured to rotate freely on a pivot point or axis. In some embodiments, these pivot points or axes may include ball bearings configured to enhance rotations and reduce friction of any of the described pulleys.

In some embodiments, the pulleys 1370 may be positioned such that while the pulleys 1324 are in contact with an inner surface of the belt 1330, the pulleys 1370 are positioned to be in contact with the outer surface of the belt 1330. The pulleys 1370 may be positioned between two pulleys 1324 as shown. The pulleys 1370 may be positioned such that the belt 1330 does not lie in a straight line along its path within the support beam 1304, but such that the pulleys 1370 offset the path of the belt 1330. In this way, the pulleys 1370 may serve to provide additional points of contact between the pulleys 1324 and the belt 1330 and provide a more reliable connection between the components.

As shown, as the pulley 1360 is turned in a direction shown by the arrow 1305, the pulleys 1324 may turn in a similar direction. However, the pulleys 1370 may rotate in an opposite direction as shown by the arrow 1306.

In some embodiments, fewer pulleys 1370 may be implemented in the driving assembly shown. For example, pulleys 1370 may be positioned between every other pair of pulleys 1324 such that from a point along the barrier 100 is positioned one pulley 1324, two pulleys 1370 on either side of the belt 1330, one pulley 1324 followed by another pulley 1324, then two pulleys 1370, and so on. Pulleys 1370 may also be placed in more scare increments. One pulley 1370 may also be positioned on one side of the belt 1330 without a pulley 1370 on the other. In some embodiments more pulleys 1370 may be positioned within the driving assembly including three, four, five, or more pulleys 1370 positioned between pulleys 1324.

As shown in FIG. 13, as the pulley 1360 is turned in a direction shown by the arrow 1305, the belt 1330 is moved in in a similar direction. As the belt 1330 is moved, it engages the pulleys 1324 either by a friction connection between two smooth surfaces or by engagement of corresponding teeth or ridges positioned on the outer surface of the pulleys 1324 and the inner surface of the belt 1330. This engagement of the pulleys 1324 cause the pulleys 1324 to rotate. As the pulleys 1324 rotate, the panels 222 coupled to the pulleys 1324 of the slats 120 also rotate. As the panels 222 rotate, the interlocking geometries 250 of the panels 222 are moved out of contact with one another. The slats 120 then may rotate to any suitable angle with respect to the barrier 100 and may increase visibility through the barrier 100 or may serve to accomplish any of the purposes previously described.

Although the configuration shown and described with reference to FIG. 13 rotates the slats 120 in a counterclockwise manner to an open position, the same principles may be applied to construct an embodiment of the barrier 100 that rotates the slats in a clockwise manner to an open position. For example, the pulley 1360 may be rotated clockwise causing the slats 120 to rotate clockwise. The panels 222 of the slats 120 may also be configured with interlocking geometries 250 in an opposite direction to allow the panels to engage and disengage in the opposite direction.

The embodiment of FIG. 13 may be advantageous because a belt and pulley system included in the driving mechanism of the barrier 100 may be more simple or cost-effective to maintain than a chain and sprocket system. In some embodiments, one or more pulleys 1370 may be mounted to a movable element that may be moved closer towards the center of the support beam 1304 to increase tension of the belt or moved farther away to decrease tension of the belt.

It is noted that the support beam 1304 shown may be either an upper support beam or a lower support beam. Similar to embodiments previously described, the pulleys shown in FIG. 13 may be positioned at a lower end of the panels 222 of the slats 120 or at an upper end of the panels 222 of the slats 120 or both similar to the embodiment shown in FIG. 8.

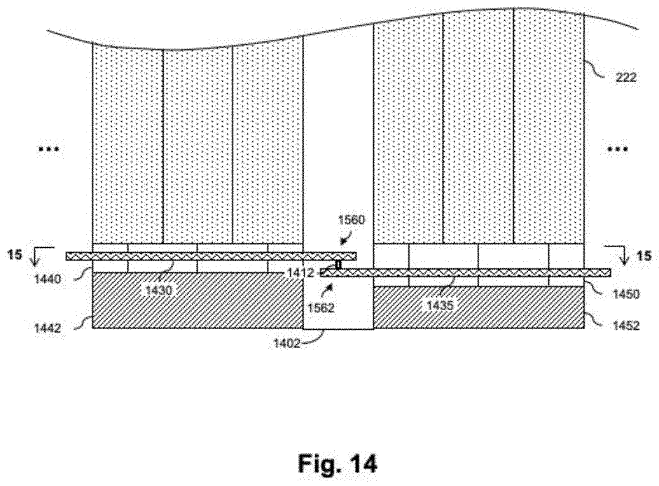

FIG. 14 is a diagrammatic side view of a section of a barrier 100 at a post 1402 with slats 120 extending from two sides, according to aspects of the present disclosure. In some embodiments, a driving mechanism 510 or similar manually driving mechanism such as shafts 1012 or 1112 may not be positioned within each post of the barrier 100. Rather, rotational motion produced by the driving mechanism may be transferred through an adjacent post to slats 120 of an additional section of the barrier 100. In some aspects as previously stated referring to FIG. 1, a set of slats 120 positioned between two posts 110 may be referred to as a single panel 105. FIG. 14 illustrates a method by which a single driving mechanism of any suitable type may rotate the slats 120 of more than one panel 105.

FIG. 14 depicts a plurality of panels 222 of slats 120 extending on either side of a post 1402, a lower support beam 1440, a support block 1442, a flexible elongate member 1430, a shaft 1412, a lower support beam 1450, a support block 1452, and a flexible elongate member 1435.

The post 1402 may be substantially similar to any of the previously described posts, including post 110, 1202, or 1302 and may include a housing, support members or blocks, or any other suitable components.

Extending on either side of the post 1402 are a plurality of panels 222 of slats 120. In some embodiments, the slats 120 on one side of the post 1402 may be included in one panel 105 and the slats on the other side of the post 1402 may be included in a difference additional panel 105. The slats 120 on one side of the post 1402 may be mechanically coupled to a lower support beam 1440 in such as a way that the slats 120 are allowed to rotate around an axis.

The lower support beam 1440 may be similar to any support beams previously described, including the lower support beam 140 or any other support beam. The support beam 1440 may include a support block 1442. The support block 1442 may be similar to previous support blocks described including support blocks 540 or other support blocks. For example, the support block 1442 may provide structural support for panels 222 of the slats 120 on either side of the post 1402 and may include or be coupled to a number of pivot rods as previously described allowing the slats 120 to rotate from a closed to an open position.

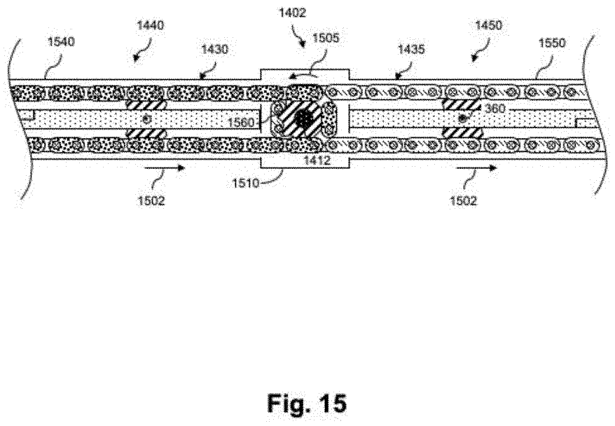

As shown in FIG. 14, a flexible elongate member 1430 extend along or within the support beam 1440. The flexible elongate member 1430 may be similar to the chain 330 described previously or any other chain previously described or may be similar to the belt 1330 of FIG. 13. In one non-limiting example, the flexible elongate member 1430 may be the chain 330 shown in FIG. 3 and FIG. 5. In this example, as the driving mechanism 510 drives the flexible elongate member 1430, causing it to move in one direction and open the slats 120 mounted to the support beam 1440, the flexible elongate member 1430 may rotate a sprocket 1560, shown in more detail in FIG. 15. It will be clear that the sprocket 1560 may be substituted for a pulley similar to the pulleys described with reference to FIG. 13 and the flexible elongate member 1430 may the chain 330 or a belt as previously described.

The sprocket 1560 may be substantially similar to any of the sprockets previously mentioned in the present disclosure. The sprocket 1560 may be mechanically bonded to a shaft 1412. The shaft 1412 may be rotated at the same rate of revolution as the sprocket 1560. The shaft 1412 may be bonded to the sprocket 1560 at one end and an additional sprocket 1562 at the other end. The sprocket 1562 may be substantially similar to the sprocket 1560. The sprocket 1560, the shaft 1412, and the sprocket 1562 may mechanically bonded such that they all rotate together in a uniform motion. In this way, rotational energy provided by the driving mechanism 510, or any suitable means of rotation, may be transferred from the sprocket 1560 in connection with the flexible elongate member 1430 to the sprocket 1562 in connection with an additional flexible elongate member 1435.

The lower support beam 1450 shown on the opposite side of the post 1402 as the lower support beam 1440 may be similar to any support beams previously described, including the lower support beam 140 or any other support beam. The support beam 1450 may include a support block 1452. The support block 1452 may be similar to previous support blocks described including support blocks 540 or other support blocks. For example, the support block 1452 may provide structural support for panels 222 of the slats 120 on either side of the post 1402 and may include or be coupled to a number of pivot rods as previously described allowing the slats 120 to rotate from a closed to an open position.

The flexible elongate member 1435 may be substantially similar to the flexible elongate member 1430 in that it may be a chain, a belt, or any other suitable type of flexible member capable of providing rotational energy to various components within the barrier 100. According to aspects of the present disclosure shown in FIG. 14, as the driving mechanism 510 or any other suitable driving mechanism rotates sprocket 360 described previously, the flexible elongate member 1430 is moved along its path in contact with the plurality of sprockets 224 within one panel 105 on one side of the post 1402. This movement of flexible elongate member 1430 causes the slats 120 of one panel 105 to rotate between various open positions and a closed position. In turn, the flexible elongate member 1430 rotates the sprocket 1560 within the post 1402 causing the sprocket 1562 to rotate in a similar manner, causing the flexible elongate member 1435 to rotate in a similar manner to flexible elongate member 1430. As the flexible elongate member 1435 moves along its path, it may engage a plurality of sprockets 224 within the second panel 105 on the other side of the post 1402 causing the slats of this panel 105 to rotate between various open positions and a closed position.

It is noted that a similar configuration to transition rotational energy may be positioned in additional posts along the barrier 100 such that one driving mechanism 510 or similar driving means may rotate the slats of multiple panels 105, including one, two, three, four, five, or more panels 105. The number of panels 105 which a single driving mechanism 510 may be capable of powering may depend on various factors, such as the weight of panels 222, the coefficient of rotational friction between panels 222 and various pivot points within the structure, the effectiveness of engagement between sprockets 224 or equivalent pulleys and flexible elongate members within the barriers, the strength of the driving mechanism 510, and various other factors.

In embodiments in which a single driving mechanism 510 or similar driving means is not capable of driving all panels 105 within the barrier 100, additional driving mechanisms may be implemented within other posts 110 or other components of the barrier 100. For example, a single driving mechanism 510 may be positioned within a post 110 configured to drive four panels 105. At a post 110 four posts away from the post 110 in which the first driving mechanism 510 is positioned, an additional driving mechanism 510 may be positioned and configured to drive a separate driving assembly capable of rotating an additional four panels 105, and so on. In such an embodiment, the multiple driving assemblies 510 may be in communication with each other via various connecting cables similar to the connecting cable 514 (FIG. 5) previously described or any other suitable cable providing signals or power. In such an example, when the user interface 570 of FIG. 5 receives an input to either open or close the slats 120 of the barrier 100, it may send a signal to all driving mechanisms within the barrier 100 to open all slats 120.

In another embodiment, the driving mechanisms 510 positioned at various locations throughout the barrier 100 may act independently of one another such that a user may select to open the panels 105 in connection with one driving mechanism while leaving panels in connection with other driving mechanisms closed. In such an embodiment, even if a driving mechanism may be capable of opening and closing several panels 105, a manufacturer of the barrier 100 may choose to position a driving mechanism within each post 110 such that a single driving mechanism only powers one panel 105. In this way, an increased amount of independence may be achieved, such that a user may selectively open and close any combination of panels 105 desired.

FIG. 15 is a diagrammatic cross-sectional top view of a section of a barrier 100 at a post 1402 with slats 120 extending from two sides, according to aspects of the present disclosure. FIG. 15 may be a cross-sectional view taken along section line 15-15 shown in FIG. 14. FIG. 15 depicts additional aspects of the configuration described with reference to FIG. 14. Specifically, FIG. 15 depicts a housing 1510 of the post 1402, a housing of the support beam 1440, and a housing of the support beam 1450.

As shown in FIG. 15, as the driving mechanism causes the flexible elongate member 1430 to move in a direction as shown by the arrow 1502, it causes the sprocket 1560 as well as the shaft 1412 and the sprocket 1562 positioned beneath the sprocket 1560 to rotate in a direction shown by the arrow 1505. As the sprocket 1562 rotates in a direction shown by the arrow 1505, it in turn moves the flexible elongate member 1435 in the same direction as the flexible elongate member 1430 as shown by the arrow 1502. In this way, the slats 120 on either side of the post 1402 may move uniformly between various open positions and a closed position.

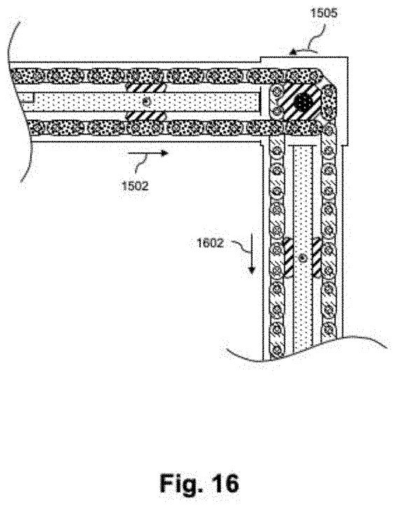

FIG. 16 is a diagrammatic cross-sectional top view of a section of a barrier 100 at a post 1402 with slats 120 extending from two sides, according to aspects of the present disclosure. It is noted and shown in FIG. 16, that the principles of translating rotational energy across a post may be achieved at any angle. For example, as shown in FIG. 16, the sprocket 1560, shaft 1412, and sprocket 1562 may transfer motion from the flexible elongate member 1430 to the flexible elongate member 1435 when the flexible elongate member 1435 extends from the flexible elongate member 1430 at a right angle.

Similarly, as the driving mechanism causes the flexible elongate member 1430 to move in a direction as shown by the arrow 1502, it causes the sprocket 1560 as well as the shaft 1412 and the sprocket 1562 positioned beneath the sprocket 1560 to rotate in a direction shown by the arrow 1505. As the sprocket 1562 rotates in a direction shown by the arrow 1505, it in turn moves the flexible elongate member 1435 in the direction shown by the arrow 1602. In this way, the slats 120 on either side of the post 1402 may move uniformly between various open positions and a closed position even if they are positioned at different angles.

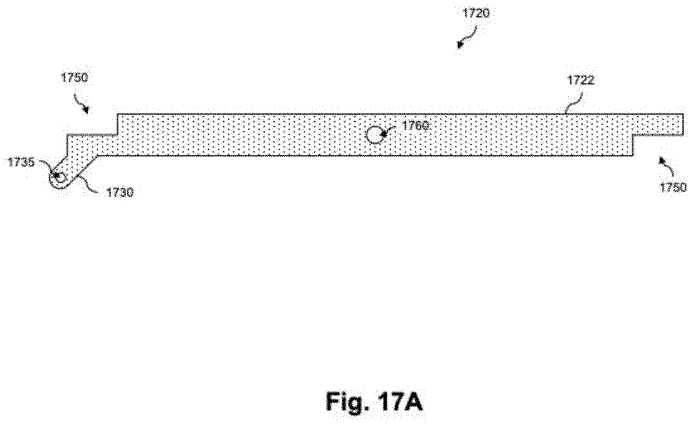

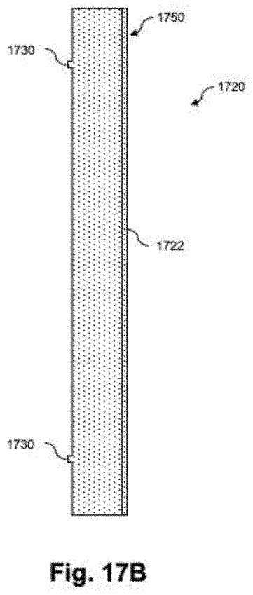

FIG. 17A is a diagrammatic top view of a slat 1720, according to aspects of the present disclosure. The slat 1720 shown in FIG. 17A may include various components and/or features including a panel 1722, interlocking geometries 1750, a cavity 1760, a protrusion 1730, and a cavity 1735.

The panel 1722 shown in FIG. 17A may be of any suitable size or shape and may be constructed of any of the materials previously mentioned. The dimensions of the panel 1722 may be similar to the dimensions of the panel 222 previously described.

The panels 1722 may all be of the same size and shape or may differ. In some embodiments, panels 1722 may include interlocking geometries 1750. As shown in FIG. 17A, the interlocking geometries 1750 may be sized and shaped to fit into one another. In other words, one end of a panel 1722 may be configured to receive the opposite end of an adjacent panel 1722. The interlocking geometries 1750 shown in FIG. 17A may be the same on both sides of the panel 1722 or may differ. The interlocking geometries 1750 may be similar to the interlocking geometries 250 of panels 222 described with reference to FIG. 2A or may differ.

The panel 1722 may additionally include a cavity 1760 as shown in FIG. 17A. The cavity 1760 may extend completely through the panel 1722 as shown and may extend lengthwise along the panel 1722. In some embodiments, however, the cavity 1760 may not extend completely through the panel 1722 but may be a recess of limited depth. The cavity 1760 may be substantially similar to the cavity 260 described with reference to FIG. 2A.

The panel 1722 may include a protrusion 1730 at one end of the panel 1722. This protrusion may extend in a diagonal manner from a corner of the panel 1722 when viewed from a top view. The protrusion may also be positioned at any other location on the panel 1722. For example, in some embodiments, the protrusion may be positioned in such a way to allow a substantially straight member to rotate around an axis of the protrusion by at least 90 degrees without coming in contact with other parts of the panels 1722 as will be described hereafter.

At a location within the protrusion 1730, an additional cavity 1735 may be positioned. In some embodiments, the cavity 1735 may be similar to the cavity 1760, in that it may extend completely through the protrusion 1735. In other embodiments, the cavity 1735 may include two recess on opposite sides of the protrusion 1735.

FIG. 17B is a diagrammatic side view of the slat 1720 of FIG. 17A, according to aspects of the present disclosure. Shown in FIG. 17B is the panel 1722 including the interlocking geometries 1750 and two protrusions 1730.

In some embodiments, the interlocking geometries 1750 discussed with reference to FIG. 17B may be configured such that when multiple panels 1722 are positioned adjacent next to another and when interlocking geometries 1750 are received into one another, the geometries 1750 are not visible. Specifically, a single straight seam between panels 1722 may be visible. In such a configuration, as shown in FIG. 17B, interlocking geometries 1750 are visible only on one side of the panel 1722. In other embodiments, interlocking geometries 1750 may be visible when panels 1722 are positioned directly adjacent to one another. In some embodiments, in a side view of a single panel 1722, interlocking geometries 1750 may be visible.

Additionally shown in FIG. 17B are protrusions 1730. The cavities 1735 described with reference to FIG. 17A may extend completely through the protrusions 1730 in the same or similar direction as the cavity 1760 or in the longitudinal direction of the slat 1720. Any suitable number of protrusions 1730 may be positioned along the panel 1722. The protrusions 1730 may be the same size, shape, or dimensions, or may differ.

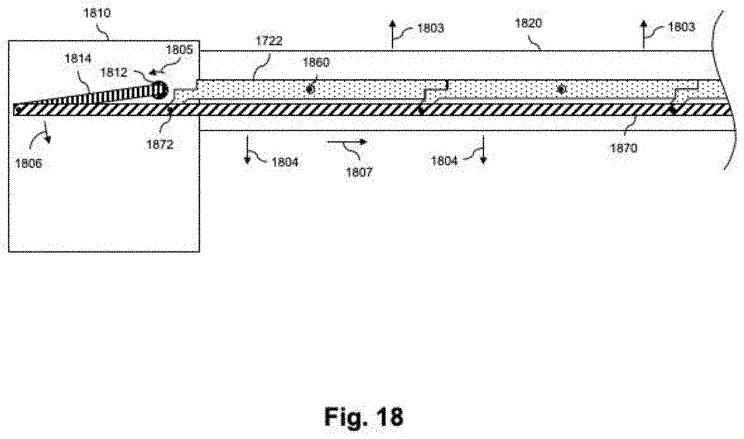

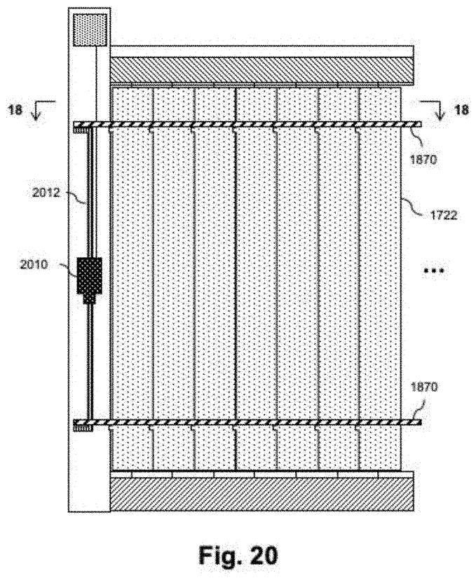

FIG. 18 is a diagrammatic cross-sectional top view of a section of a barrier 100 in a closed position, according to aspects of the present disclosure. The embodiment shown in FIG. 18 presents a different version of a driving assembly that eliminates the need of flexible elongate members, sprockets, pulleys, or similar components which may be costly. FIG. 18 may depict an additional aspect of a means of rotating the slats 120 shown previously. FIG. 18 is a cross-sectional view taken along section line 18-18 hereafter shown in FIG. 20. FIG. 18 includes a cross-sectional top view of a post 1810 and a support member 1820. The post 1810 may additionally include a housing, a shaft 1812 in connection with a driving mechanism, and an arm 1814. The support member 1820 may additionally include a housing, a plurality of slats 120 shown previously including panels 1722 and pivot rods 1860. A rigid driving member 1870 is additionally depicted with a plurality of rotating fasteners 1872. The combination of driving members, rotating fasteners, a driving mechanism, a shaft and arm as well as various other components shown in FIG. 18 may be referred to as a driving assembly.

The post 1810 shown in FIG. 18 may include a housing. In other embodiments, the post 1810 may be a solid post such that no components are situated within the post 1810. The post 1810 may be substantially similar to other posts previously described. As shown in FIG. 18, multiple components are shown within the post 1810. The shaft 1812 may be positioned along a longitudinal axis of the post 1810 and may be positioned at any other location within the post 1810. The shaft 1812 may be mechanically coupled to a supporting component allowing the shaft 1812 to rotate. The shaft 1812 may be of any suitable shape, width, or diameter.

The shaft 1812 may be mechanically coupled to an arm 1814. The shaft 1812 may be coupled to the arm 1814 in such a way that as the shaft 1812 is rotated around a center axis, the attached arm 1814 turns around the same axis at the same rate of revolution. The shaft 1812 may extend upward along the post 1810 or downward and may be coupled to various other components within the post 110. For example, multiple arms 1814 may be positioned in connection with the shaft 1812. In some embodiments, the number of arms 1814 positioned in connection with the shaft 1812 may be the same as the number of protrusions positioned on any one slat 1720. In some embodiments, and as will be shown and described hereafter, the shaft 1812 may be coupled to a driving mechanism such as an electric motor or handle that may be manually turned.

Additionally shown in FIG. 18 is the rigid driving member 1870. The driving member 1870 may be of any suitable type and may be of any suitable material. In an exemplary and non-limiting aspect, the member 1870 in FIG. 1870 may be an elongate, straight, rigid component. However, in other embodiments, the member 1870 may be of any suitable shape or may take any suitable path. The member 1870 may include a plurality of cavities into which rotating fasteners 1872 may be positioned. The locations of these cavities along the rigid driving member 1870 may correspond to the locations of protrusions on the plurality of slats 1720 extending along the barrier 100. In this way, each protrusion of the slats 1720 may be fastened to the rigid driving member 1870. Each protrusion is fastened in such a way to allow the protrusions to rotate or pivot with respect to the driving member 1870.

A similar connection to the connection types used to fasten the protrusions of the slats 1720 to the driving member 1870 may be implemented at one end of the arm 1814 to fasten the arm to the end of the driving member 1870 as shown in FIG. 18.

As shown in FIG. 18, as the shaft 1812 is turned in a direction shown by the arrow 1805, the arm 1814 is turned in a direction shown by the arrow 1806. As the arm 1814 turns in a direction shown by the arrow 1806, the rigid driving member 1870 is moved in a direction shown by the arrow 1807. As this motion occurs, the connection between the arm 1814 and member 1870 pivots to allow the angle of the arm 1814 to change as it is rotated while the driving member 1870 remains parallel to the direction of the barrier 100. As the driving member 1870 moves in a direction shown by the arrow 1807, the slats 1720 of the barrier 100 are rotated. Specifically, one side of the slats 1720 are moved in a direction shown by the arrow 1803 and the other side of the slats 1720 are moved in a direction shown by the arrow 1804. As the slats 1720 rotate, they turn about the axis formed by the cavity 1760 (FIG. 17A) and a number of pivot rods 1860. The pivot rods 1860 may be substantially similar to the pivot rods 340 previously described with reference to FIG. 3. This motion of the driving member 1870 as it is moved by the rotating shaft 1812 and arm 1814 cause the panels 1722 of the slats 1720 to rotate counterclockwise to an open position. As the panels 1722 rotate, the interlocking geometries 1750 of the panels 222 are moved out of contact with one another. The slats 1720 then may rotate to any suitable angle with respect to the barrier 100 and may increase visibility through the barrier 100 or may serve to accomplish any of the purposes previously described.

Although the configuration shown and described with reference to FIG. 18 rotates the slats 1720 in a counterclockwise manner to an open position, the same principles may be applied to construct an embodiment of the barrier 100 that rotates the slats in a clockwise manner to an open position. Such an embodiment may position the rigid driving member 1870 on the opposite side of the slats 1720. For example, the shaft 1812 and arm 1814 may be rotated clockwise causing the slats 1720 to rotate clockwise. The panels 1722 of the slats 1720 may also be configured with interlocking geometries 1750 in an opposite direction to allow the panels to engage and disengage in the opposite direction.

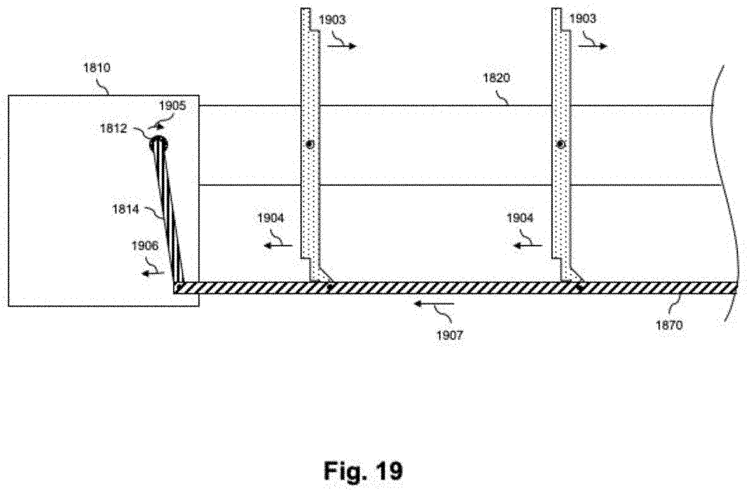

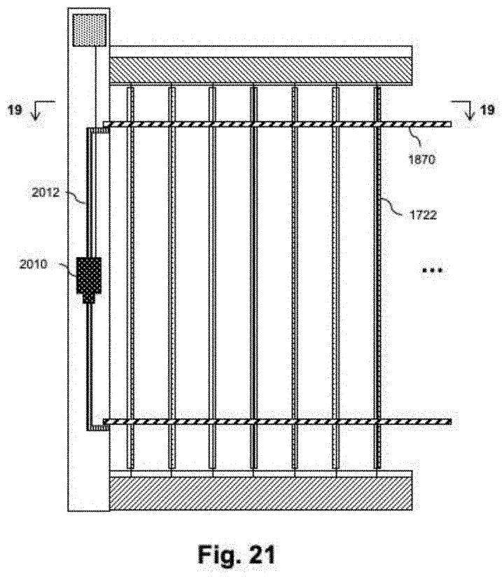

FIG. 19 is a diagrammatic cross-sectional top view of a section of a barrier 100 in an open position, according to aspects of the present disclosure. FIG. 19 is a cross-sectional view taken along section line 19-19 of FIG. 21. In an open position, the panels 1722 of the slats 1720 may be positioned substantially perpendicular to the direction of the barrier 100. In other embodiments, however, the panels 1722 may be positioned at any suitable angle relative to the direction of the barrier 100 as shown allowing varying levels of visibility through the barrier 100. For example, the panels 1722 may be positioned at any angle between 0 degrees and a maximum angle similar to the range of angles previously described with reference to FIG. 4.

To bring the panels 1722 of the slats 1720 back into a closed positioned, like the one shown in FIG. 18, the shaft 1812 may be turned clockwise as shown by the arrow 1905 causing the arm 1814 to turn in a direction shown by the arrow 1906. As shown in FIG. 19, as the shaft 1812 and arm 1814, which may be one unitary structure or may be separate structures, are turned clockwise, the rigid driving member 1870 is moved in the direction shown by the arrow 1907. As the driving member 1870 is moved in the direction shown by the arrow 1907, the sections of the slats 1720 including the protrusions 1730 are moved in a direction shown by the arrows 1904 and the opposite ends are moved in a direction shown by the arrow 1903. This movement causes the slats 1720 to rotate in a clockwise direction. As the panels 1722 continue to rotate until the panels 1722 are brought to an angle of 0 degrees again, the interlocking geometries 1750 of the panels 1722 are moved into contact with one another. The slats 1720 then prevent all visibility through the barrier 100 or may serve to accomplish any of the purposes previously described.

In some embodiments, the driving member 1870 is visible to a user of the barrier 100 standing adjacent to the barrier 100. As shown in figures hereafter, the member 1870 may be positioned perpendicularly across the slats 1720.

FIG. 20 is a diagrammatic side view of a section of a barrier 100 in a closed position, according to aspects of the present disclosure. As shown, in a closed position, visibility through the barrier 100 may be completely or substantially limited. FIG. 5 depicts the slats 1722, a shaft 2012, rigid driving members 1870, and a driving mechanism 2010. The embodiment shown in FIG. 20 may also include any other suitable characteristics or features described in the present disclosure.

The driving mechanism 2010 may be substantially similar to the driving mechanism 510 previously described with reference to FIG. 5. The driving mechanism may be coupled to the shaft 2012. The shaft 2012 shown is a unitary structure. It may, however, be similar, or accomplish a similar purpose as the shaft 1812 and arm 1814 as described with reference to FIG. 18 and FIG. 19. For example, the shaft 2012 may be rotated by the driving mechanism 2010 and case the driving member 1870 to move in a parallel direction with the barrier 100 opening or closing the slats 1720.

FIG. 21 is a diagrammatic side view of a section of a barrier 100 in an open position, according to aspects of the present disclosure. Similar to the position shown and described with reference to FIG. 19, in an open position, the panels 1722 of the slats 120 may be rotated in such a way that they are substantially perpendicular to the upper and lower support beams or the general longitudinal direction of the barrier 100. In an open position, the barrier 100 may allow increased visibility through the barrier 100 as well as serve other purposes as previously stated. In other embodiments, the panels 1722 may be set to any suitable position or angle with respect the barrier 100 so as to modify the visibility, air or water flow, or otherwise modify the position and/or purpose of the barrier 100.

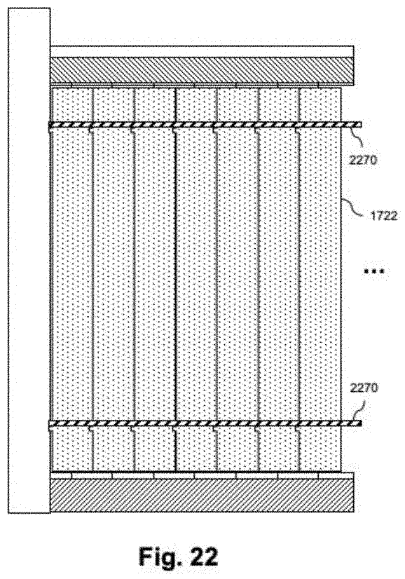

FIG. 22 is a diagrammatic side view of a section of a barrier 100, according to aspects of the present disclosure. The embodiment shown in FIG. 22 may provide an additional means of driving the slats 1720 so as to rotate them between various open positions and a closed position. For example, the embodiment shown in FIG. 22 may eliminate the need for an electric driving mechanism, or the rotating manual driving mechanism previously described. FIG. 22 depicts rigid driving members 2270.

Rigid driving members 2270 may be similar to members 1870 described with reference to FIG. 18. However, driving members 2270 may not be connected to a driving mechanism via an arm 1814, shaft 1812, or shaft 2012. Driving members 2270 may be similarly connected to the protrusions 1730 of the panels 1722 as shown in FIG. 22. However, the driving members 2270 may be moved by a user of the barrier 100. For example, a user may grasp the one driving member 2270 and manually move the member 2270 in a direction parallel to the direction of the barrier 100. In some embodiments, the driving member 2270 may include various handles or other devices to aid a user in grasping and moving the member 2270. Such devices may include additional protrusions, padded enclosures, surfaces to aid in gripping by increasing friction between a user's hand and the surface of the driving member 2270 or other devices and methods.

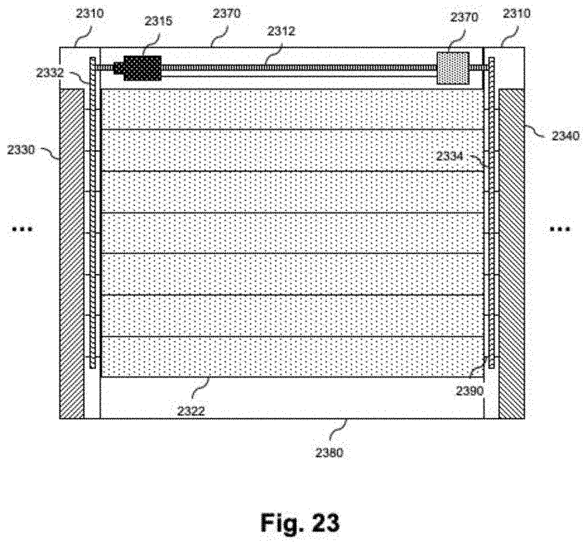

FIG. 23 is a diagrammatic side view of a section of a barrier 100, according to aspects of the present disclosure. FIG. 23 may depict similar aspects, components, characteristics and features as previously described in previous embodiments but at a difference orientation. FIG. 23 depicts posts 2310, support blocks 2330 and 2340, flexible elongate members 2332 and 2334, an upper support member 2370, a lower support member 2380, a driving mechanism 2315, a shaft 2312, a user interface 2370, pivot rods 2390, and panels 2322.

As shown, rather than extending between support beams as previously described, the panels 2322 may also be positioned between posts 2310. In such an embodiment, pivot rods 2390 may also extend between posts 2310 and may be fastened to support blocks 2330 and 2340. Panels 2322 may be substantially similar to panels 222, panels 1722, or any other panels previously described in the present application. Pivot rods 2390 may also be substantially similar to pivot rods 340 previously described. Support blocks 2330 and 2340 may also be substantially similar to any support blocks previously described in the present disclosure. The posts 2310 may also be substantially similar to any posts previously described.

Shown in FIG. 23, the driving mechanism 2315 is shown positioned within the upper support beam 2370. However, the driving mechanism 2315 and the component to which it is connected may alternatively be positioned the lower support beam 2380. The driving mechanism 2315 may be substantially similar to the driving mechanism 510 or any other driving mechanism previously described, including a manually driven mechanism. The shaft 2312 may be substantially similar to the shaft 350, 812, or any other shaft previously described. The user interface 2370 may also be substantially similar to the user interface 570 previously described.

The flexible elongate members 2332 and 2334 may be substantially similar to any of the flexible elongate members described in the present application. Specifically, they may be in connection with various sprockets in connection with the slats 2322 shown as well as the shaft 2312 in order to be driven by the driving mechanism 2315.

Finally, it is noted that any of the principles described with reference to any of the previous figures or embodiments may also be implemented in the embodiment shown in FIG. 23 including a manual driving mechanism, a driving mechanism utilizing sprockets, pulleys, flexible elongate members, rigid driving members in connection with protrusions on slats, or any other characteristics or features.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A barrier, comprising:
a post;
a support beam coupled to the post;
one or more slats coupled to the support beam wherein the one or more slats are additionally coupled to a flexible elongate member; and
a driving mechanism coupled to the flexible elongate member, wherein the driving mechanism is configured to move the flexible elongate member, and wherein the flexible elongate member causes the one or more slats to rotate as it is moved.

2. The barrier of claim 1 comprising a second flexible elongate member wherein the driving mechanism and the slats are coupled to the second flexible elongate member.

3. The barrier of claim 1, wherein the slats are positioned directly adjacent to one another such that, at a first closed position, the slats prevent visibility through the fence and, at a second open position, the slats allow visibility through the fence.

4. The barrier of claim 1, wherein the slats comprise interlocking geometries.

5. The barrier of claim 1, wherein the flexible elongate member is a chain.

6. The barrier of claim 5, wherein the driving mechanism is coupled to a first sprocket configured to receive the chain and wherein the slats are coupled to additional gears configured to receive the chain.

7. The barrier of claim 6, wherein the driving mechanism is configured to turn the first gear causing the slats to rotate between one or more open positions and a closed position.

8. The barrier of claim 1, wherein the flexible elongate member is a belt and wherein the driving mechanism further comprises a first pulley configured to receive the belt and wherein the slats are each additionally coupled to an additional pulley configured to receive the belt such that when the driving mechanism turns the first pulley, the slats rotate between one or more open positions and a closed position.

9. The barrier of claim 1, wherein the driving mechanism is an electric motor configured to move the flexible elongate member upon receiving a user input.

10. The barrier of claim 9, wherein the user input is a wireless signal.

11. The barrier of claim 9, wherein the electric motor electrically coupled to a battery, and wherein the battery is electrically coupled to and charged by a solar panel.

12. The barrier of claim 1, wherein the driving mechanism is configured to be rotated or moved manually by a user.

13. A fence comprising:
a post;
a support beam coupled to the post; and
one or more slats coupled to the support beam wherein each slat is additionally coupled to a cross beam configured to be moved laterally by a user.

14. The fence of claim 13, wherein each slat is coupled to the support beam by a rotating pivot.

15. The fence of claim 14, wherein each slat is configured to rotate between one or more open positions and a closed position when a user moves the cross beam.

16. The fence of claim 13, wherein the slats are positioned directly adjacent to one another such that, at a first closed position, the slats prevent visibility through the fence and, at a second open position, the slats allow visibility through the fence.

17. The fence of claim 13, wherein the slats comprise interlocking geometries.

18. The fence of claim 13, wherein the post is a first post, and wherein the one or more support beams each have a first and a second end, the first end being coupled to the first post and the second end being coupled to a second post positioned adjacent to the first post.

19. The fence of claim 13, wherein the one or more slats are positioned parallel to one another.

20. A fence, comprising:
a first post comprising a housing and a driving mechanism positioned within the housing, the driving mechanism being coupled to a flexible elongate member and wherein the driving mechanism is configured to move the flexible elongate member;
a second post positioned adjacent to and parallel to the first post;
two or more support beams positioned between the first post and second post; and
one or more slats comprising a first and a second end, the first end coupled to one of the support beams and the second end coupled to a different support beam, wherein the one or more slats are additionally coupled to the flexible elongate member such that the slats rotate between one or more open positions and a closed position when the driving mechanism moves the flexible elongate member.
